(19) United States
(12) Patent Application Publication
(10) Pub. No.: US 2026/0131464 A1
(43) Pub. Date: May 14, 2026

(54) METHOD FOR CONTROLLING ONE OR MORE ACTUATORS OF A HUMANOID ROBOT

(71) Applicant: Figure AI Inc., San Jose, CA (US)

(72) Inventor: Michael Rose, San Jose, CA (US)

(21) Appl. No.: 19/384,836

(22) Filed: Nov. 10, 2025

Related U.S. Application Data
(60) Provisional application No. 63/717,945, filed on Nov. 8, 2024.

(51) Int. Cl. B25J 9/16

(52) U.S. Cl. CPC B25J 9/1664

(57) ABSTRACT

The present disclosure provides a method for controlling actuators of a humanoid robot, comprising setting kinematic parameters for a footstep including swing period, determining a horizontal trajectory for the footstep, obtaining sensor data from sensors associated with the robot, determining terrain heights at points along the horizontal trajectory based on the trajectory and sensor data, formulating a quadratic programming problem to determine a vertical trajectory that minimizes a cost function subject to constraints including initial state constraint, final state constraint, and terrain avoidance constraints requiring vertical position at each point to be greater than or equal to terrain height plus height buffer, solving the quadratic programming problem to determine the vertical trajectory, and controlling actuators to execute the footstep based on the determined horizontal and vertical trajectories.

### CROSS-REFERENCE TO RELATED APPLICATIONS

This application claims the benefit of and priority to U.S. Provisional Patent Application Nos. 63/717,945, filed on Nov. 8, 2024, which is fully incorporated herein by reference.

### TECHNICAL FIELD

The present disclosure relates to humanoid robot control systems, and more particularly to a method for controlling one or more actuators of a humanoid robot using optimized foot trajectory planning and risk-based action selection.

### BACKGROUND

Robotic systems are increasingly being deployed in various operational environments, ranging from controlled industrial settings to dynamic, unstructured environments originally designed for humans. Humanoid robots, characterized by their bipedal structure and anthropomorphic form, are particularly well-suited for these human-centric environments as they can theoretically utilize the same tools, navigate the same passageways, and perform similar tasks as human workers. However, effectively operating a humanoid robot presents significant technical challenges. Unlike wheeled or tracked robots, humanoid robots require continuous active control to maintain balance, especially during locomotion. Generating dynamically feasible motion plans that allow a robot to walk, turn, and manipulate objects without falling requires solving complex high-dimensional problems in real-time.

Conventional approaches to humanoid control often struggle with two major extremes of operation: high-level goal interpretation and low-level actuator control. At the high level, translating abstract, long-horizon user commands (e.g., “retrieve the box from the top shelf”) into a concrete sequence of executable robotic actions is difficult. Existing systems often require highly structured, explicit step-by-step instructions, limiting their autonomy and usability by non-technical operators. At the low level, specifically regarding bipedal locomotion, planning foot trajectories that avoid obstacles while maintaining stability is computationally intensive. Traditional methods may rely on pre-computed gait libraries that are brittle when facing unforeseen terrain irregularities, or they may employ complex full-body trajectory optimization that is too slow for real-time reaction to sudden environmental changes. For example, a simple spline-based foot trajectory might cause a robot to trip over a small obstacle it failed to clear, while a fully optimized trajectory might take too long to compute, causing the robot to pause or lose balance while waiting for the next step command. Accordingly, there is a need for improved control architectures that can seamlessly integrate high-level semantic understanding of tasks with robust, real-time low-level motion planning and execution, particularly for generating optimized, collision-free foot trajectories in varied terrain.

### SUMMARY

The presently disclosed subject matter is directed to a method for controlling one or more actuators of a humanoid robot. Particularly, the method comprises setting kinematic parameters for a footstep, the kinematic parameters including a swing period. The method includes determining a horizontal trajectory for the footstep to be executed over the swing period. The method includes obtaining sensor data from at least one sensor associated with the humanoid robot. The method includes determining, based on the horizontal trajectory and the sensor data, a plurality of terrain heights at a corresponding plurality of points along the horizontal trajectory. The method includes formulating a quadratic programming (QP) problem to determine a vertical trajectory for the footstep, wherein the QP problem minimizes a cost function subject to a set of constraints, the set of constraints comprising an initial state constraint for the vertical trajectory, a final state constraint for the vertical trajectory, and a plurality of terrain avoidance constraints, each terrain avoidance constraint corresponding to one of the plurality of points, wherein each terrain avoidance constraint requires a vertical position of the vertical trajectory at the respective point to be greater than or equal to the terrain height determined for that point plus a height buffer. The method includes solving the QP problem to determine the vertical trajectory. The method includes controlling one or more actuators of the humanoid robot to execute the footstep based on the determined horizontal trajectory and the determined vertical trajectory.

The presently disclosed subject matter is directed to a method for controlling one or more actuators of a humanoid robot. Particularly, the method comprises producing a first action proposal using a first policy. The method includes predicting a risk score of the first action proposal. The method includes, responsive to the risk score being at or below a threshold, transmitting the first action proposal to a whole-body controller. The method includes, responsive to the risk score being above the threshold, determining a bridge plan for use while a revised action proposal is being generated, transmitting the bridge plan to the whole-body controller for immediate execution, using a second policy to generate the revised action proposal, wherein the second policy is different from the first policy, and transmitting the revised action proposal to the whole-body controller. The method includes using the whole-body controller to control the one or more actuators of the humanoid robot based on at least one of the first action proposal, the bridge plan, or the revised action proposal transmitted to the whole-body controller.

The presently disclosed subject matter is directed to a method for controlling one or more actuators of a humanoid robot. Particularly, the method comprises determining a horizontal component of a foot trajectory for a single footstep of the humanoid robot. The method includes determining terrain height along the horizontal component of the foot trajectory. The method includes determining state constraints for the footstep based on initial and final vertical positions derived from the terrain height. The method includes calculating an optimized vertical foot trajectory by solving a constrained optimization problem that minimizes a cost function subject to the state constraints and terrain clearance constraints, wherein the optimized vertical foot trajectory provides collision-free foot movement while maintaining dynamic feasibility for bipedal locomotion.

In some embodiments, the terrain clearance constraints comprise adding a constraint for minimum swing height by determining a minimum height as a predetermined value added to a maximum of initial vertical position and final vertical position, iterating for each interior time step in a swing length, and adding a constraint for each interior time step that vertical position is greater than terrain height plus a height buffer that is phased in and out gradually over the swing length to prevent over-constraining the optimization problem at liftoff and touchdown.

The presently disclosed subject matter is directed to a humanoid robot system. Particularly, the system comprises a plurality of actuators configured to control movement of leg assemblies and foot assemblies. The system includes one or more sensors configured to detect terrain height data. The system includes a computing architecture including a foot placement planner configured to generate foot trajectories. The system includes a whole body controller configured to convert the foot trajectories into joint torque commands for the plurality of actuators, wherein the foot placement planner is configured to solve a quadratic programming problem to determine an optimized vertical foot swing trajectory that satisfies terrain clearance constraints and kinematic limits while minimizing energy consumption.

The presently disclosed subject matter is directed to a method for optimizing foot swing trajectories in bipedal locomotion. Particularly, the method comprises setting kinematic parameters including foot swing time, minimum vertical height, and height buffer values. The method includes generating discrete time dynamics for a system model having at least second-order dynamics with states including vertical position and vertical velocity. The method includes determining a horizontal trajectory for a footstep using spline interpolation. The method includes sampling terrain height at discrete time intervals along the horizontal trajectory. The method includes formulating a quadratic programming problem with cost functions penalizing position, velocity, and acceleration deviations. The method includes adding constraints ensuring vertical position exceeds terrain height plus a safety margin at each time interval. The method includes solving the quadratic programming problem to generate an optimized foot trajectory that avoids terrain collisions while maintaining smooth motion profiles.

The presently disclosed subject matter is directed to a computing system for humanoid robot control. Particularly, the system comprises a processor. The system includes memory storing instructions that, when executed by the processor, cause the system to perform operations including receiving sensor data indicative of terrain topology, determining initial and final foot positions for a planned footstep, generating a constrained optimization problem that includes terrain clearance constraints and dynamic feasibility constraints, solving the constrained optimization problem using quadratic programming to determine an optimized foot trajectory, and outputting control signals to actuators of the humanoid robot based on the optimized foot trajectory, wherein the optimization problem minimizes a cost function that balances energy efficiency with trajectory smoothness.

The presently disclosed subject matter is directed to a method for real-time foot trajectory planning in humanoid robots. Particularly, the method comprises discretizing a foot swing period into a plurality of time intervals. The method includes, for each time interval, determining a horizontal foot position along a predetermined horizontal trajectory. The method includes querying terrain height at each horizontal foot position using sensor data. The method includes formulating state constraints that enforce initial liftoff conditions and final touchdown conditions. The method includes constructing a quadratic cost function that penalizes vertical position deviations, velocity changes, and acceleration magnitudes. The method includes adding inequality constraints that maintain foot clearance above terrain surfaces with a configurable safety margin. The method includes iteratively solving the resulting quadratic program to generate smooth, collision-free vertical foot trajectories that enable stable bipedal walking on uneven terrain.

The presently disclosed subject matter is directed to a humanoid robot foot trajectory optimization system. Particularly, the system comprises a perception system configured to generate elevation maps of surrounding terrain. The system includes a movement controller including a foot placement planner configured to determine horizontal foot placement locations. The system includes a trajectory optimization module configured to solve constrained optimization problems for vertical foot swing paths, wherein the trajectory optimization module implements third-order dynamics with states including vertical position, velocity, and acceleration, and uses jerk as a control input to generate smooth trajectories that satisfy terrain clearance requirements and kinematic constraints. The system includes actuator controllers configured to execute the optimized trajectories through joint torque commands to leg and foot actuators.

The presently disclosed subject matter is directed to a computer-readable storage medium storing instructions that, when executed by a processor of a humanoid robot control system, cause the processor to perform operations. Particularly, the operations comprise receiving terrain data representing ground topology along a planned walking path. The operations include determining swing phase parameters including swing duration and horizontal foot displacement. The operations include modeling foot dynamics using discrete-time state equations with position and velocity states. The operations include formulating an optimization objective that minimizes energy expenditure while maintaining trajectory smoothness. The operations include incorporating terrain avoidance constraints that ensure foot clearance above detected obstacles with adaptive safety margins. The operations include solving the optimization problem using quadratic programming techniques to generate feasible foot swing trajectories. The operations include transmitting trajectory commands to robot actuators to execute the optimized foot movements during bipedal locomotion.

The presently disclosed subject matter is directed to a method for optimizing a foot trajectory for a humanoid robot. Particularly, the method comprises determining a horizontal component of a foot trajectory for a single footstep. The method includes performing dense sampling of terrain height along the horizontal component of the foot trajectory. The method includes dividing the horizontal component into a reduced number of optimization sample bins. The method includes determining a representative terrain height for each optimization sample bin by selecting the peak terrain height from the dense samples captured within that bin. The method includes calculating an optimized vertical foot trajectory by solving a constrained optimization problem, wherein the problem uses the representative peak terrain height for each bin as a terrain clearance constraint.

The presently disclosed subject matter is directed to a method for real-time foot trajectory generation in a humanoid robot. Particularly, the method comprises accessing a precomputed library of discrete candidate foot trajectories, wherein the library includes trajectories spanning from conservative, rounded profiles to aggressive, square profiles. The method includes receiving, in real-time, terrain data along a planned horizontal foot path. The method includes iteratively checking the validity of the precomputed candidate foot trajectories against the received terrain data to identify collisions. The method includes selecting the first candidate foot trajectory from the library that is validated as collision-free against the terrain data. The method includes commanding actuators of the humanoid robot to execute the selected collision-free trajectory.

The presently disclosed subject matter is directed to a humanoid robot control system. Particularly, the system comprises a perception system configured to determine a position of a stance foot relative to a center of mass or hip of the humanoid robot. The system includes a foot placement planner configured to continuously monitor the position of the stance foot relative to a predefined boundary and operate in an event-triggered mode, initiating the generation of a new footstep trajectory only upon detecting that the stance foot has exited the predefined boundary.

The presently disclosed subject matter is directed to a method for navigating a humanoid robot over uneven terrain. Particularly, the method comprises generating, by a perception system, elevation maps from sensor data. The method includes segmenting the elevation maps into planar regions and classifying said regions based on slope and roughness. The method includes extracting a set of steppable convex polygons from the classified planar regions. The method includes formulating a footstep planning problem, wherein the steppable convex polygons are passed to a planner and used as discrete foothold constraints. The method includes solving the planning problem, using techniques such as Mixed-Integer Quadratic Programming (MIQP), to select a sequence of optimal footholds and timings that adhere to the convex polygon constraints.

In some embodiments, a perception system comprises visual sensors, such as RGB cameras and depth-sensing cameras, which may be positioned within a head assembly of the humanoid robot. This system is configured to generate three-dimensional terrain maps or elevation maps from the sensor data, potentially utilizing convolutional neural networks for object recognition and depth estimation. In some embodiments, a horizontal foot trajectory is determined, for example, by a foot placement planner. This horizontal trajectory may be generated using cubic spline interpolation with boundary conditions applied to ensure zero horizontal velocity at liftoff and touchdown.

In some embodiments, an optimized vertical foot trajectory is calculated by solving a constrained optimization problem, which may be formulated as a quadratic programming (QP) problem. The foot swing period may be discretized into a number of time intervals, such as between 10 and 40 equal-duration intervals. The optimization utilizes discrete-time state equations, which in some embodiments use third-order dynamics. These states may include vertical position, vertical velocity, and vertical acceleration, with a control input comprising vertical jerk to generate smooth trajectories.

In some embodiments, the quadratic programming problem includes a cost function with penalties for position, velocity, and acceleration, which may be scaled by a discrete time step to improve numerical stability. The optimization is subject to constraints, including initial and final state constraints that may set vertical acceleration to zero for smooth liftoff and touchdown while maintaining dynamic feasibility. Terrain avoidance constraints are also applied, requiring the vertical foot position to exceed the sampled terrain height plus an adaptive safety margin at interior time intervals. This safety margin may be phased in and out gradually over the swing length, reducing buffer amounts toward the beginning and end of the swing, to prevent over-constraining the problem.

In some embodiments, this trajectory planning operates within a hierarchical control architecture. A high-level policy (S2) may process task and sensor data to generate abstract information, such as a semantic latent vector, which is provided to a reactive policy (S1). The reactive policy, which may be a trained neural network such as a transformer or diffusion policy, generates action proposals by fusing data streams including user commands, sensory data, and internal robot state. These proposals may be evaluated for risk (e.g., collision or stability violations), and actuator controllers convert the final optimized trajectories into joint torque commands, for example, through a whole-body controller that enforces rigid-body dynamics and friction constraints.

### BRIEF DESCRIPTION OF THE DRAWINGS

The drawing figures depict one or more implementations in accordance with the present teachings, by way of example only, not by way of limitation. These figures are intended to illustrate and not to restrict the scope of the disclosure. In the figures, like reference numerals refer to the same or similar elements. This convention is maintained throughout the drawings for consistency.

FIG. 1 is a diagram illustrating an environment and a network in which one or more humanoid robots of FIG. 1 may operate, connect, command or be commanded by, control or be controlled by, and/or interact;

FIG. 2 is a block diagram illustrating components of the humanoid robot of FIG. 1;

FIG. 3A is a perspective view of the humanoid robot of FIGS. 1-2;

FIG. 3B is a diagram illustrating actuators contained within the humanoid robot of FIG. 1-3A and the corresponding rotational axes of said actuators;

FIG. 4 is a block diagram of sensors for the humanoid robot of FIGS. 1-3B;

FIG. 5 is a block diagram of a communication interface for the humanoid robot of FIGS. 1-3B;

FIG. 6 is a block diagram of a movement controller for the humanoid robot of FIGS. 1-3B;

FIG. 7 is a block diagram of a behavior manager for the humanoid robot of FIGS. 1-3B;

FIG. 8A is a block diagram of an onboard artificial intelligence (AI) system for the humanoid robot of FIGS. 1-3B;

FIG. 8B is a diagram of the architecture of an AI that may be used by the onboard AI system for the humanoid robot of FIGS. 1-3B;

FIG. 9 is a diagram depicting an interaction of components contained within a computing architecture of the humanoid robot of FIGS. 1-3B;

FIG. 10 is a diagram showing operations for the humanoid robot of FIGS. 1-3B to perform a specified task;

FIG. 11 is a diagram showing movement of the humanoid robot of FIGS. 1-3B along a foot trajectory;

FIG. 12 is a flowchart of operations that may be performed to plan vertical foot swing trajectory for a humanoid robot using a constrained optimization problem;

FIGS. 13 and 14 are a flowchart of operations that may be performed with a discrete quadratic programing optimization problem for planning vertical foot swing trajectory for a humanoid robot; and

FIGS. 15 and 16 illustrate simulated results that may be achieved by a humanoid robot performing the methods of FIGS. 12-14.

### DETAILED DESCRIPTION

In the following detailed description, numerous specific details are set forth by way of examples in order to provide a thorough understanding of the relevant teachings. These examples are illustrative and not exhaustive. It should be apparent to those skilled in the art that the scope of the teachings is not limited to these specific details. Additionally or alternatively, well-known methods, procedures, components, and/or circuitry have been described at a relatively high-level, without detail, in order to avoid unnecessarily obscuring aspects of the present disclosure.

While this disclosure includes several embodiments, there is shown in the drawings and will herein be described in detail certain embodiments with the understanding that the present disclosure is to be considered as an exemplification of the principles of the disclosed methods and systems and is not intended to limit the broad aspects of the disclosed concepts to the embodiments illustrated. As will be realized, the disclosed methods and systems are capable of other and different configurations, and one or more details are capable of being modified, all without departing from the scope of the disclosed methods and systems. For example, one or more of the following embodiments, in part or whole, may be combined consistent with the disclosed methods and systems. As such, one or more steps from the flow charts or components in the Figures may be selectively omitted and/or combined consistent with the disclosed methods and systems. Additionally, one or more steps from the flow charts or the method of assembling the shoulder and upper arm may be performed in a different order. Accordingly, the drawings, flow charts and detailed description are to be regarded as illustrative in nature, not restrictive or limiting.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C). The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### A. INTRODUCTION

The presently disclosed technology is directed at a specific, practical application in the field of robotics and provides a tangible improvement to the functioning of humanoid robot control systems. The control of a humanoid robot presents a concrete technical problem rooted in physical mechanics: the need to coordinate a high-degree-of-freedom mechanical system to perform physical tasks in a dynamic, unpredictable environment. Conventional whole-body controllers struggle because they must solve the computationally intensive problems of inverse kinematics and inverse dynamics in real time-a task whose complexity, involving dozens of simultaneous variables and constraints, is well beyond the capacity for mental calculation. This challenge is magnified when attempting to simultaneously satisfy multiple, often competing, objectives such as task goals, physical constraints, and crucial safety limits. The disclosed methods address these technological shortcomings not with an abstract idea, but with a specific, structural improvement to the robot's control architecture. This improvement yields a direct and measurable enhancement to the machine's operation, resulting in a humanoid robot that is more computationally efficient, physically safer, and more capable of performing complex real work.

The disclosed method is more efficient over conventional systems because it integrates multiple, distinct technical elements that are often handled separately and less effectively in conventional systems into a single, combined inverse kinematics problem that a more efficient system can handle. The disclosed method also does not preclude all other uses of quadratic program solvers, but rather is focused on a specific, inventive application that is directly tried to humanoid robots. Finally, by generating control instructions that inherently and simultaneously balance task execution with safety and stability, the method enables the robot to perform physical actions faster, consume less computational power which extends operational battery life, and operate more safely and predictably around humans and obstacles. This constitutes a direct and significant improvement to the functionality, reliability, and technical capabilities of the humanoid robot as a machine.

### B. DEFINITIONS

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Although selected human medical terminology is used to describe features and/or relative positions related to the bipedal or humanoid robot, it should be understood that said medical terminology may not directly correspond to the exact same features of a human. It should be understood that names of various assemblies and components (e.g., including housings and assemblies contained within) may generally relate to a location of similar anatomy of a human body and may not have an exact correlation in dimension, function, or shape. The reference system including three orthogonal reference planes is defined with respect to the robot in a neutral standing position to describe relative positions of components of the robot. Although standard human medical terminology is used to describe the anatomical reference planes (i.e., sagittal, coronal, transverse) of the robot, the planes may be shifted from the typical location on a human to be meaningful for the kinematic layout and features of the robot.

Humanoid Robot: a robot that is capable of bipedal locomotion and includes components (e.g., head, torso, etc.) that generally resemble parts of a human. However, the robot does not need to include every part of a human (e.g., hands with over ten degrees of freedom), nor do its components need to have a shape that exactly or substantially resembles human parts. Furthermore, it should be understood that a humanoid robot is not designed to be primarily quadruped or have a wheeled base.

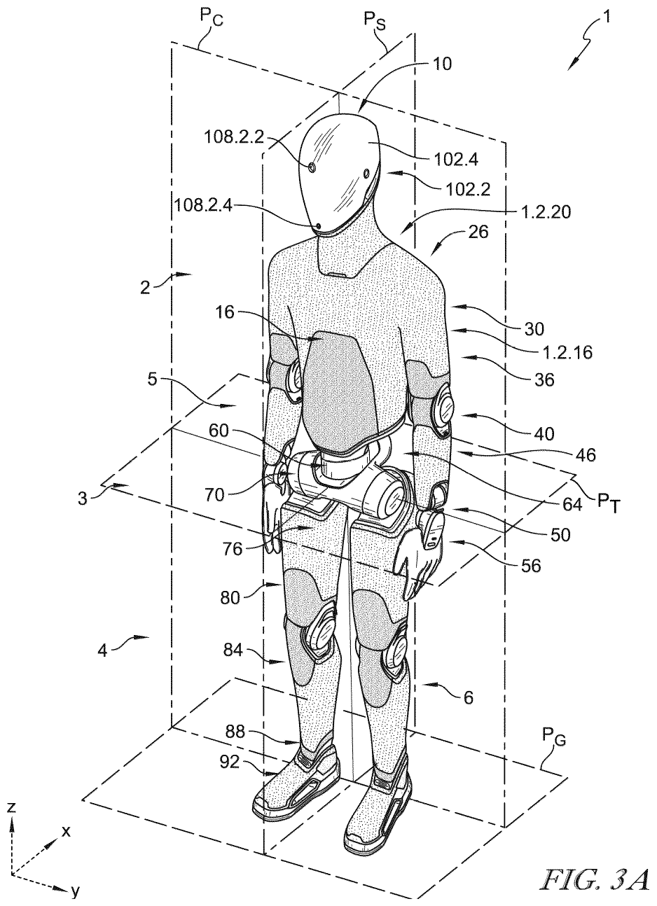

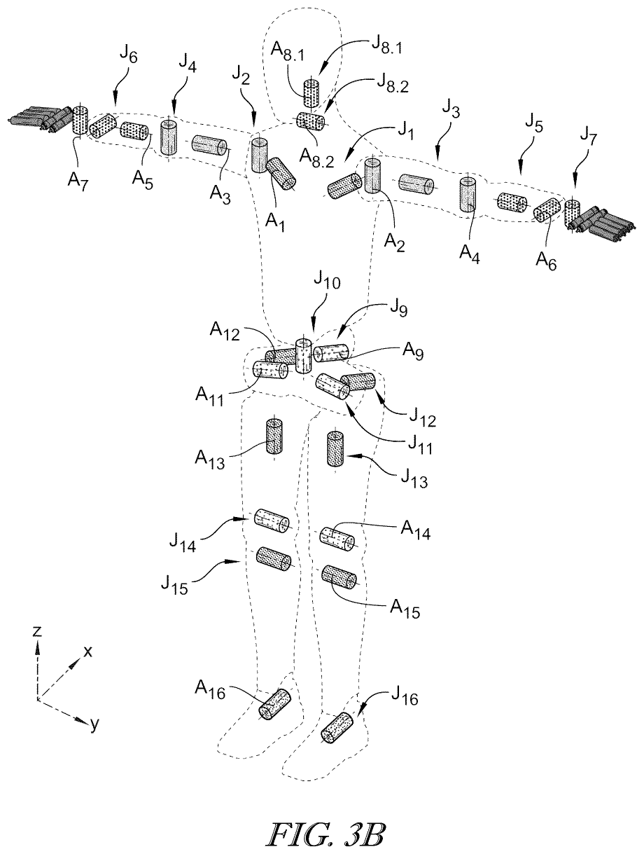

Neutral State: a state where the robot is standing upright on a horizontal support surface (P_{G}) and facing a forward direction with its torso substantially vertically aligned over its pelvis and legs, where the legs are substantially straight with the knees substantially aligned under the hips and substantially above the ankles, such that the robot's weight is balanced over its feet. In the neutral state, the robot's head is facing forward (i.e., in the forward direction), the arms are located at the sides of the robot, the hands are oriented with the palms facing substantially inward, and the fingers pointing in a substantially downward direction toward the horizontal support surface. An illustrative example of the neutral state for the humanoid robot 1 is shown FIG. 3A.

Extended State: a state of the robot with the arms extended outward laterally at the shoulder (as illustrated in FIG. 3B) and oriented with the palms of the hands substantially facing downward and the fingers pointing in a substantially outward direction, where the central and lower portions of the robot remain in a neutral state.

Sagittal Plane: a vertical plane when the robot is in the neutral state that aids in defining left and right sides of the robot for all states. Accordingly, the sagittal plane may: (i) divide the robot and/or the torso into left and right portions or halves, (ii) extend through an axis of rotation about which the torso twists or rotates relative to the pelvis and legs, (iii) contain an origin point of the robot, and/or (iv) be positioned between the left and right legs, and/or left and right arms. In an illustrative embodiment, the sagittal plane (P_{S}) (e.g., as illustrated in FIG. 3A) is a vertical plane positioned at a midway point between the left and right legs and the left and right arms and contains a rotational axis A₁₀ of a torso twist actuator (J10) (e.g., as illustrated in FIG. 3B) located in the spine 60 of the robot 1 and divides the left and right sides of the robot 1 (e.g., as illustrated in FIG. 3A). In other words, in an illustrative embodiment, the sagittal plane (P_{S}) is a plane that is colinear with the rotational axis A 10 of the torso twist actuator (J10).

Coronal Plane: a vertical plane when the robot is in the neutral state that aids in defining front and back portions of the robot for all states. Accordingly, the coronal plane may: (i) divide the robot and/or the torso into front and back portions or halves, (ii) contain an axis of rotation about which the torso pitches forward or backward from the neutral state, (iii) contain an axis of rotation of a knee joint about which a lower shin pitches forward and backward, and/or (iv) contains an axis of rotation of an elbow joint about which a lower forearm moves forward and backward, when the robot is in the extended state. In various embodiments, said axis of rotation for torso pitch may be two colinear axes, a single centrally located axis, an axis defined by a line connecting the midpoints of two non-collinear actuator axes that provide the torso pitch function, or an axis defined by a line connecting the center of actuator bearings of two actuators that provide the torso pitch function. In the illustrative embodiment (see, e.g., FIGS. 3A and 3B), the coronal plane (PC) is a vertical plane that contains the rotational axes A₁₁ of the hip flex actuators (J11) located in the hips 70 (and likewise may contain an axis defined by a line connecting the midpoints of a left hip flex actuator (J11) axis (A₁₁) and a right hip flex actuator (J11) axis (A₁₁) and rotational axis A₁₀ of torso twist actuator (J10) located in the spine 60 of the robot 1. As shown in these figures, the coronal plane (P_{C}) does not bisect the robot, or torso, into equal front and back halves, as it is offset forward of a majority of the arm actuators in the extended position, and other positional relationships that can be understood from the figures.

Transverse Plane: a horizontal plane that aids in defining the upper and lower portions of the robot. Accordingly, the transverse plane may: (i) divide the robot into upper and lower portions or halves, and/or (ii) contain an axis of rotation about which the torso pitches forward or backward, as discussed above. In the illustrative embodiment, the transverse plane (P_{T}) is a horizontal plane that contains the mid-point of the rotational axes A₁₁ of the hip flex actuators (J11) located in the hips 70 of the robot 1.

Origin Point: an orthogonal intersection point of the sagittal plane, coronal plane, and transverse plane, all of which extend through the humanoid robot disclosed herein. In the illustrative embodiment of the robot 1 shown in FIG. 3A, an origin point (Cp) is present and shown.

Reference Axes: consist of: (i) the Z-axis (vertical) is defined pursuant to the intersection of the sagittal plane and coronal plane, (ii) the Y-axis (horizontal) is defined pursuant to the intersection of the coronal plane and transverse plane; and (iii) the X-axis (depth) is defined pursuant to the intersection of the sagittal plane and transverse plane. FIG. 3A illustrates example Z, Y, X reference axes where the sagittal, coronal, and transverse planes share a common origin point.

Kinematic Chain: a representation of an assembly of rigid bodies connected by joints to provide constrained motion. Within this application, e.g., FIG. 3B, a kinematic chain is illustrated by cylindrical bodies, where the respective central axis of each individual cylindrical body represents the position and orientation of the axis of rotation for the individual joints. For example, each rotary actuator has a central rotational axis. Other types of actuators may include linkages that provide rotational movement about one or more rotational axes via linkages, bearing or other rotation features, or other means.

Range of Motion: a range of rotational motion of an actuator about an axis of rotation, where a first and second angle define a rotational limit in opposing rotational directions from a neutral position of the actuator with the limits expressed in Radians.

Degrees of Freedom (DoF): the number of parameters that define the configuration of the kinematic chain and possible movements associated therewith.

Singularities: geometric configurations of the robot's joints in which one or more degrees of freedom are effectively lost due to the alignment or overlap of rotational or translational axes, which in some cases is also affected by interference of extents of components where one or more of the components are moved by the joint.

Actuator Bearing: a specific component of the individual actuator that is generally ring-shaped with parallel edge guides, wherein the rotational axis (Aₙ) of the actuator is centered within the actuator bearing and orthogonal to the parallel edge guides. Within this application, the actuator bearings of individual actuators are referenced to further define orientation of the rotational axes and/or relative size of the individual actuator.

Actuator bearing plane (Bₙ): a plane defined mid-width of actuator bearing between parallel edge guides and orthogonal to the rotational axis (Aₙ).

Textile: a flexible (e.g., fabric-like), highly durable cover material that has high elastic stretch capabilities and is resistant to pilling, abrasions, and cuts. A textile includes both common textiles (e.g., traditional woven cloth), engineered textiles, and non-fabric-like materials (e.g., plastics or polymers), and/or a combination of the above.

### C. ROBOT(S) AND ENVIRONMENT

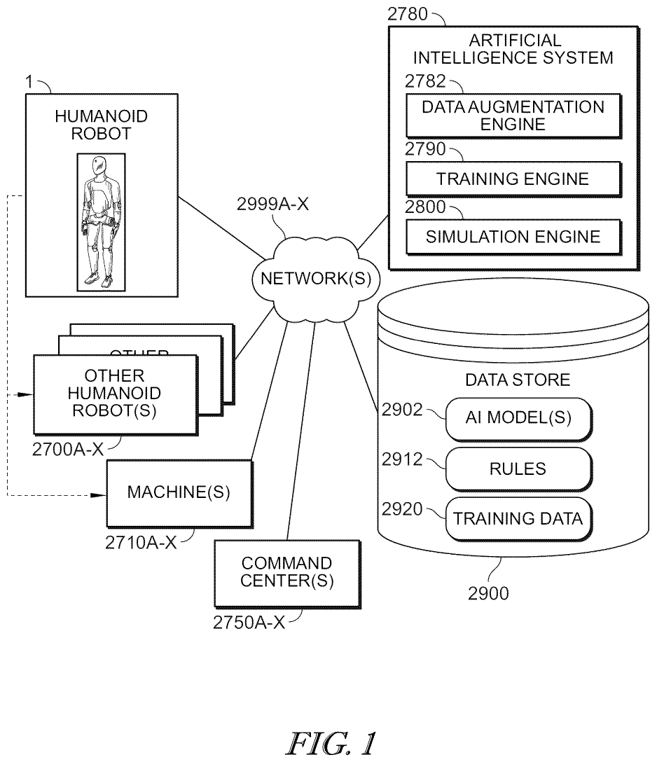

FIG. 1 illustrates an exemplary network and/or operational environment in which a humanoid robot (also referred to as a bipedal robot) 1, which is further detailed in additional figures herein, may operate. The environment may include a plurality of interconnected components, such as: (i) the humanoid robot 1, (ii) one or more other humanoid robots 2700A-X which may the same as or different from the robot 1, (iii) one or more machines 2710A-X, (iv) one or more command centers 2750A-X, (v) one or more remote artificial intelligence (AI) system(s) 2780 which are remote from the robot 1, such as a cloud-base AI system, and (vi) one or more data stores 2900. Each component may be interconnected with another component, directly or indirectly, by at least one of: (i) one or more networks 2999A-X, (ii) direct communication systems (not illustrated—e.g., a data store 2900 may have direct communication with a remote AI system 2780) and/or (iii) physical contact with one another (e.g., the humanoid robot 1 may be in direct physical contact when operating a machine 2710A-X). The one or more networks 2999A-X may include, for example, the Internet, a local area network, a wide area network, a private network, a cloud computing network, or a network based on a wireless communication protocol. Additionally, it should be understood that the humanoid robot 1 may be interconnected with one or more other humanoid robots 2700A-X through a wireless communication protocol, such as a Bluetooth connection or a connection based on a near-field communication protocol, or through a wired connection.

The humanoid robot 1 may be collocated with one or more of the other humanoid robots 2700A-X to collectively or separately perform a given task or workflow. Such operations may occur, e.g., at a worksite such as a factory, warehouse, industrial facility, or home. Furthermore, the humanoid robot 1 may also be situated in a separate geographical location relative to other humanoid robots 2700A-X. For example, the humanoid robot 1 may be located in a given worksite, while another humanoid robot 2700A-X is located at another worksite in a different geographical location.

The operational environment may generally include machines 2710A-X, which may be embodied as any device, heavy machinery, or object with which a humanoid robot 1 and/or other humanoid robots 2700A-X may interact. For instance, a machine 2710A-X can include, among other things, tools, packaging machinery, forklifts, drilling machines, pallet movers, HVAC equipment, carts, bins, and platform machines.

The command centers 2750A-X may be comprised of one or more physical computing devices or virtual computing instances executing on a local or cloud network. These centers 2750A-X may be utilized for one or more of monitoring, managing, and configuring tasks, as well as for issuing control directives to the humanoid robot 1 and other humanoid robots 2700A-X at one or more worksites. A command center 2750A-X may be collocated with any of the humanoid robot 1 or the other humanoid robots 2700A-X, or it may be located in a different geographical location from the robots 1 and other humanoid robots 2700A-X. The computing devices of the command centers 2750A-X may execute software that is used to monitor (e.g., charge level, task performance, etc.), manage the robots 1 and other humanoid robots 2700A-X, and/or transmit long-horizon goals, tasks, and control directives to the robots 1 and other humanoid robots 2700A-X over the networks 2999A-X. Additionally and as such, the humanoid robots 1 and other humanoid robots 2700A-X may each be configured to: (i) send data to the command centers 2750A-X, (ii) perform a given task based on the transmitted long-horizon goals, tasks, and control directives, and/or (iii) infer a task based on the transmitted long-horizon goals, tasks, and control directives.

The command centers 2750A-X may determine, based on available humanoid robots 1 and the capabilities of each robot, which of the robots may be best suited for a given task. For example, the command centers 2750A-X may identify a humanoid robot 2700A-X to transfer parts to the other room once they are placed in the jig. The command centers 2750A-X may thereafter relay the assignment to the assigned other humanoid robot 2700A-X, which may be identified based on a unique identifier (e.g., serial number) assigned to each of the humanoid robots 1 and 2700A-X, and also to the other humanoid robots 2700A-X to indicate which other humanoid robot 2700A-X has been assigned the task.

The remote AI system 2780 may be comprised of one or more computing devices that are configured to perform global operations related to AI/ML for the entire computing environment. For example, the remote AI system 2780 may store, retrieve, and otherwise manage data within the data store 2900. This data may include one or more AI models 2902, rules 2912, and training data 2920. The AI models 2902 may be embodied as any type of model that: (i) can be run in an environment that is remote from the humanoid robot 1 and 2700A-X, while being in communication with the humanoid robot 1 to enable the humanoid robots 1 and 2700A-X to perform the functions described herein (e.g., observing, reasoning, and performing tasks), (ii) can be sent to the humanoid robot 1 and 2700A-X, where the humanoid robot 1 and 2700A-X runs the model locally to perform the functions described herein, and/or (iii) can be used in the training of any model described herein. For instance, the AI models 2902 may comprise artificial neural networks, convolutional neural networks, recurrent neural networks, generative adversarial networks, variational autoencoders, diffusion models, transformer models, natural language processing models (e.g., speech-to-text and/or text-to-speech), object detection models, image segmentation models, facial recognition models, transfer learning models, autoregressive models, large language models, visual language models, vision-action models, multi-modal language models, graph neural networks, reinforcement learning models, or any other type of model known in the art or disclosed herein. The rules 2912 may be comprised of sets of rules and conditions that are used to enable: (i) deterministic behavior by the humanoid robot 1 and the other humanoid robots 2700A-X, (ii) training the models that enable the humanoid robots 1 and 2700A-X to perform the functions described herein, and/or any other known rule. For example, the rules 2912 may include any combination of finite state machines, reactive control protocols, safety rules, configuration files, task sequencing protocols, safety protocols, and/or protocols for compliance with standards, safety, morals and/or regulations.

The training data 2920 may be embodied as any type of data that is used to train one or more of the AI models 2902. For example, the training data 2920 may include: (i) image data, such as raw image data, annotated image data, or synthetic data comprising computer-generated images used to augment real image datasets, particularly in instances where usable data is scarce; (ii) video data, such as raw video data, annotated video data, or synthetic data; (iii) text data, such as natural language instructions, dialogue data, machine-readable instructions, or natural language mapping data; (iv) depth data, such as map data or point cloud data; (v) robot joint trajectories; (vi) robot joint locations; (vii) robot joint location data, which may be obtained from teleoperation of a robot; (viii) robot joint rotations data, which may also be obtained from teleoperation of a robot; (ix) other robot sensor data, such as inertial measurement unit (IMU) data, force and torque data, or proximity sensor data; (x) simulation data; (xi) human demonstration data, such as first person or third person images or videos of humans performing a task; (xii) robot demonstration data, such as images or videos of other robots performing a task; (xiii) any combination of the aforementioned data types; and/or (xiv) any other known data type. For clarity, it should be understood that any data type that is described above may be either labeled or unlabeled.

The remote AI system 2780 may include a data augmentation engine 2782, a training engine 2790, and a simulation engine 2800. The data augmentation engine 2782 may be embodied as any combination of hardware, software, or circuitry that is configured to increase the size and diversity of the training data 2920, particularly in instances where the training data is limited. For example, the data augmentation engine 2782 may be configured to perform: (i) image augmentation of visual data such as images and video frames (e.g., identifying anatomical point and/or kinematic chains), (ii) sensor data augmentation to simulate real-world inaccuracies like noise, thereby assisting in training the AI models 2902 to account for such inaccuracies, (iii) trajectory augmentation to modify the speed or timing of movements, which assists the AI models 2902 in learning to recognize and adapt to different behaviors, or to alter the trajectories or paths of the robot 1 in simulations, and (iv) domain randomization, which involves altering parameters including textures, lighting, and object positions.

The illustrative training engine 2790 may be embodied as any combination of hardware, software, or circuitry for training the AI models 2902, given a set of rules 2912 and training data 2920. To do so, the training engine 2790 may apply a variety of AI/ML techniques, such as supervised learning techniques (e.g., classification, regression), unsupervised learning techniques (e.g., clustering, dimensionality reduction, anomaly detection), semi-supervised learning techniques (e.g., training with both labeled and unlabeled data), reinforcement learning techniques (e.g., model-free methods, model-based methods), ensemble learning, active learning, and transfer learning techniques (e.g., by leveraging pre-trained models 2902). It should be understood that each of these techniques may be applied online or offline.

The simulation engine 2800 may be embodied as any combination of hardware, software, or circuitry for executing one or more of the AI models 2902 within a virtualized simulation environment. This allows for the simulation and analysis of various aspects of the humanoid robot 1, such as its kinematics, sensor behavior, overall behavior, anomalies, and the like. For example, the simulation engine 2800 may generate the simulation environment based on real-world mapping data that was previously observed and/or generated by the humanoid robot 1 or other humanoid robots 2700A-X, or that was obtained from third-party services. The simulation engine 2800 may also generate a physics-accurate model of the humanoid robot 1, which has a specified configuration (e.g., a physical structure, joints, sensors, actuators, and other components with predefined parameter sets). The data generated from the simulations may then be used by the training engine 2790 to build, train, alter, fine-tune, or modify a previously generated model, a new model, and/or rules. Advantageously, the simulation engine 2800 is designed to improve efficiencies in the manufacture, testing, and deployment of a given humanoid robot 1 for a specified purpose.

The remote AI system 2780 may account for the substantial computing and resource demands required by AI/ML-based techniques by processing at least a portion of data, requests, and/or training. As such, the humanoid robots 1 may be configured with considerably less powerful compute, network, and storage resources. For instance, the humanoid robot 1 may prioritize certain processes, such as those relating to the performance of a presently assigned task, and offload other processes, such as the refining of local AI/ML models, to the remote AI system 2780. The remote AI system 2780 may also periodically update the humanoid robots 1 and 2700A-X with refined AI models 2902 and training data 2920, or it may receive updates and propagate them to the robots 1, for instance, via over-the-air updates or push subscription-based updates. The remote AI system 2780 may also push updated rules 2912 to the robots 1 and 2700A-X. Additionally, the remote AI system 2780 may receive data from each of the humanoid robots 1 and 2700A-X, which may include behavioral information, learning information, model reinforcement data, and the like. The remote AI system 2780 may store such data as training data 2920 and subsequently use this data to refine the AI models 2902.

Although FIG. 1 depicts the data augmentation engine 2782, the training engine 2790, and the simulation engine 2800 as executing on a single remote AI system 2780, one of skill in the art will recognize that each of these engines may execute on separate systems or computing nodes associated with the remote AI system 2780. Such an arrangement may be advantageous in improving the performance and resource management of each of the engines 2782, 2790, and 2800.

### D. HUMANOID ROBOT

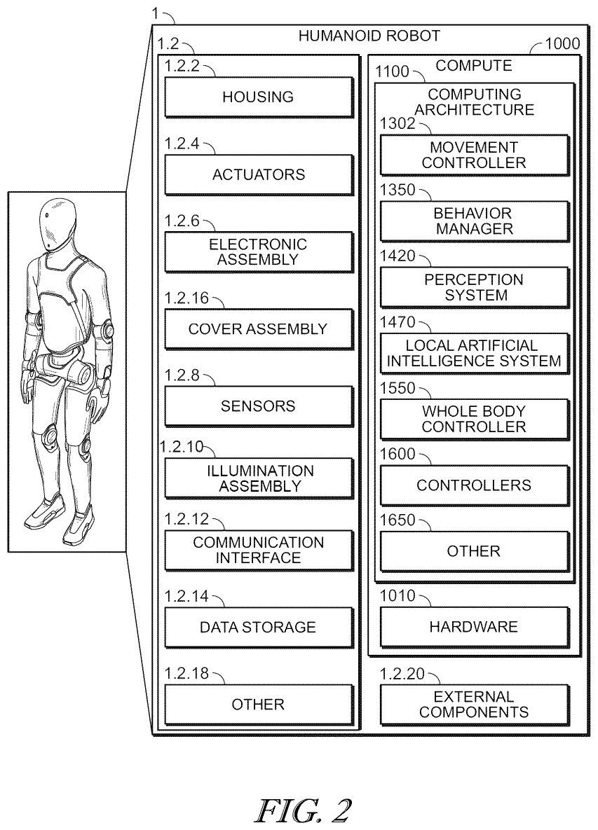

FIG. 2 is a block diagram of a humanoid robot 1 that includes a variety of architectures and other components that may include: (i) a mechanical/electrical architecture 1.2 that includes housings 1.2.2, actuators 1.2.4, electronic assembly 1.2.6, sensors 1.2.8, communication interface 1.2.12, illumination assembly 1.2.10, data storage 1.2.14, exterior covering assembly 1.2.16, external components 1.2.20, other components 1.2.18, and (ii) compute 1000 that includes a computing architecture 1100.

a. Humanoid Robot Configuration

The high-level configuration for the robot 1 includes assemblies that function together to provide the robot with a humanoid shape and enable said robot to perform human-like movements. As such, the structures and kinematic principles that are inherent to non-humanoid systems cannot be simply adopted or implemented into a humanoid robot 1 without undergoing careful analysis and empirical verification against the complex realities of design, testing, and manufacturing. Theoretical designs that attempt such direct modifications are insufficient, and in some instances woefully insufficient, because they amount to mere design exercises that are not tethered to the complex realities of successfully creating a functional, general-purpose humanoid robot.

i. Robot Components

In addition to the general systems, assemblies, components, and parts described above, the humanoid robot 1 in the illustrative embodiment shown in FIG. 3A may include the following systems, assemblies, components, and parts, which can be broadly categorized into three regions. As shown in FIG. 3A, these three regions include: (i) an upper portion 2, which includes a head and neck assembly 10, a torso 16, left and right arm assemblies 5, and left and right hands 56; (ii) a central portion 3, which includes a spine 60, a pelvis 64, and left and right upper leg assemblies 6.1 of left and right leg assemblies 6; and (iii) a lower portion 4, which includes left and right lower leg assemblies 6.2 of leg assemblies 6.

In the illustrative embodiment shown in FIG. 3A, each arm assembly 5 may include a shoulder 26, an upper humerus 30, a lower humerus 36, an upper forearm 40, a lower forearm 46, and a wrist 50. The hand 56 is coupled to the wrist 50. Each leg assembly 6 may include: (i) an upper leg assembly 6.1, which may comprise a hip 70, an upper thigh 76, and a lower thigh 80, and, (ii) a lower leg assembly 6.2, which may comprise a shin 84, a talus 88, and a foot 92. In other embodiments, some of these systems, assemblies, components, or parts may be omitted, combined, or replaced with alternative designs.

### 1. Head and Neck Assembly

The head and neck assembly 10 of the humanoid robot 1 may be designed to enhance its anthropomorphic characteristics, while also providing functional capabilities that support interaction, perception, and communication. The head and neck assembly 10 is coupled to a torso 16 and possesses an overall shape that generally resembles the general shape of a human head. The head and neck assembly 10 is, however, specifically designed to lack pronounced human facial structures, such as cheeks, eye protrusions, a mouth, or other moving parts, to maintain a non-humanlike appearance. The exterior surface of the head 10.1 is characterized by an absence of large flat surfaces (e.g., the head 10.1 is not a cube or prism) and the head is also not formed with significant cylindrical features or perfect circles. Instead, almost all exterior surfaces of the head 10.1 are curvilinear or contain substantial curvilinear aspects, which presents a generally egg-shaped appearance when viewed from the front or top.

Structurally, the head 10.1 is symmetrical about the sagittal plane P_{S} but is asymmetrical about Z-Y and X-Y planes that intersect the head and are parallel to the coronal plane (P_{C}) and the transverse plane (P_{T}), respectively. The width (parallel to the y-axis) and depth (parallel to the x-axis) of the head 10.1 change constantly from top to bottom, reaching a maximum dimension in the temple region, which is located at approximately 30-50% of the head's height from its top end.

The head 10.1 itself may house a range of components, such as high-resolution cameras, microphones, and displays, all of which are contained within an impact-resistant polymer shell 102.2. This shell 102.2 includes a large, freeform (i.e., not conforming to a regular or formal structure or shape) frontal shield 102.4 that covers the frontal and crown regions of the head 10.1. The frontal shield 102.4 is formed as a separate and distinct piece from the displays positioned behind it, thereby protecting the displays and internal electronics from damage. This separation provides a significant advantage during the performance of industrial tasks, as a damaged frontal shield 102.4 is substantially cheaper and easier to replace than a damaged display. The frontal shield 102.4 extends rearward beyond an auricular region into an occipital region and extends down to a chin region, but it does not extend below a jaw line.

Cameras embedded within the head 10.1 may include RGB, depth-sensing, thermal imaging capabilities and/or any other cameras disclosed herein, which are designed to enable the humanoid robot 1 to perform tasks such as object recognition, environmental mapping, and facial expression analysis. For the specific purpose of generating a low-latency Virtual Reality (VR) view, a pair of high-resolution, high-frame-rate RGB cameras with global shutters may be utilized. For example, this pair of cameras may be the vertically arranged cameras 108.2.2 and 108.2.4, or they may be horizontally arranged internal/external cameras. Microphones may be arranged in an array to facilitate directional audio input and noise cancellation, which enhances the ability of the humanoid robot 1 to understand and respond to verbal commands.

Displays integrated into the head 10.1 may serve as user interfaces, providing visual feedback or conveying expressions to improve communication and user engagement. Unlike the heads of conventional robots, the disclosed head 10.1 includes a main display 108.4 that is curved in at least one direction and is positioned at an angle relative to a sagittal plane. This curved design permits the inclusion of a larger display with a greater surface area compared to a flat screen, which increases the amount of information that can be conveyed, such as robot status and sensor data. This information is displayed using generic blocks or shapes rather than anthropomorphic features like eyes or a mouth. In addition to the main display 108.4, two side-facing displays are included to show indicia such as the identification number/serial number, battery life, current task, any required safety indicia, and/or any other information associated with the humanoid robot 1.

Further, an extent of the illumination assembly 1.2.10, which comprises a plurality of light emitters, is positioned adjacent to an edge (e.g., lower) of the frontal shield 102.4. These light emitters may be configured to function as indicator lights to communicate the status of the robot 1 to nearby humans—for instance, by emitting light that appears to humans in different colors (e.g., yellow for working, green for idle, red for an error state, or blue for thinking) or illumination sequences—without relying on the main displays. This method of communication may be more power-efficient than displays, and may relay information more rapidly.

Additionally, the head 10.1 may house: (i) other sensors, such as gyroscopes and accelerometers, (ii) heat management systems (e.g., heat pipes, fans, etc.), (iii) wireless communication modules (e.g., 5G cellular, Wi-Fi, Bluetooth) and antennas. To maximize bandwidth and ensure connectivity, a plurality of 5G cellular radios may be positioned in the torso 16 and wired through the neck to the antennas in the head 10.1. The head and neck assembly 10 may also incorporate advanced materials and shock-absorbing structures to protect the sensitive electronic components housed within, which may improve the overall durability and reliability of the humanoid robot 1.

The head and neck assembly 10 may include two primary actuators: a head twist actuator (J8.1) 120, which is responsible for enabling rotational movement of the head 10.1 about axis A_{8.1}, which is a vertical (yaw) axis when the robot is in the neutral state, and a head nod actuator (J8.2) 140, which enables rotation of the head 10.1 about the axis A_{8.2}, which is a horizontal axis when the robot is in the neutral state. Together, these two actuators may provide two degrees of freedom for the head 10.1, allowing it to perform movements that emulate natural human head motions. The head twist actuator (J8.1) 120 may be positioned within the head and neck assembly 10, while the head nod actuator (J8.2) 140 may be located at the base of the neck. This head twist actuator (J8.1) 120 and head nod actuator (J8.2) 140 may each utilize a motor, a gear reduction system, and sensors or encoders that are similar to the actuator types discussed herein.

The head actuators, J8.1 and J8.2, may work in coordination to position the head 10.1 accurately, enabling the humanoid robot 1 to track objects, focus on specific areas of interest, or maintain eye contact during human-robot interactions. The actuators may be controlled, in conjunction with input from visual and inertial sensors, to execute smooth, human-like movements. For example, the head twist actuator (J8.1) 120 may rotate the head 10.1 to follow a moving object, while the head nod actuator (J8.2) 140 adjusts the pitch to maintain an optimal viewing angle.

Variations of this design may include the addition of a third actuator to provide roll motion, which would further increase the range of movement of the head 10.1 to three degrees of freedom (3-DoF) and could enable more expressive head gestures, such as tilting the head sideways to convey curiosity or empathy. Alternatively, for specialized applications, the actuators (J8.1) and/or (J8.2) may be replaced with compact linear actuators or parallel-link mechanisms.

Additionally, variations of head 10.1 may include modular head designs that allow for the quick customization or replacement of sensory and communication components. These modular designs may facilitate easy upgrades or modifications to the capabilities of the humanoid robot 1 without requiring extensive changes to the overall head and neck assembly 10. Furthermore, advanced control algorithms may be implemented to enable more natural, biomimetic head movements, potentially incorporating machine learning techniques to adapt and refine the motion patterns of the head 10.1 based on interaction data and environmental feedback.

### 2. Torso

The torso assembly 16 is a central component within the humanoid robot 1, extending vertically between the waist and the head and neck assembly 10, and horizontally between the shoulders 26. The torso 16 is designed to provide the robot 1 with a generally humanoid shape, offer structural and operable support for the arm assemblies 5 and the head and neck assembly 10, and house and protect internal components, including the arm actuators (J1) 190 and an electronics assembly 1.2.6 housed at least partially within the torso 16.

The electronics assembly 1.2.6 within the torso 16 contains various interconnected components that are essential for the operation of the robot 1, including the battery pack, the compute 1000 (which includes CPUs and GPUs), power distribution unit, and a charging system. The components are strategically positioned to optimize space and balance. The battery pack may be rearwardly offset, positioned in a rear section of the torso 16, while the compute 1000 is placed in a forward section. This spatial distribution helps to maintain a balanced posture, allows for efficient cooling, and maximizes the size and power density of the battery pack. A cooling system may be integrated between the battery pack and the compute 1000 to manage their respective thermal loads. The electronics assembly 1.2.6 may be designed with modularity to facilitate easier maintenance, repair, and upgrades. The charging system may support both wired and wireless protocols. A wired system might use a docking station, while a wireless system could utilize inductive charging, with coils that may be embedded in a housing 1.2.2 and/or the feet 92. The charging system may also include safety features such as overcharge protection and temperature monitoring.

The torso 16 may have a total volume of more than 10 liters, preferably more than 15 liters, and most preferably more than 20 liters. However, the torso 16 has a total volume that is less than 40 liters and most preferably less than 30 liters. The torso 16 also has an uninterrupted internal height that is more than 250 mm, and is preferably near to 300 mm, but is less than 350 mm. This substantial internal volume may accommodate a battery pack that exceeds 2 liters, preferably more than 4 liters, and most preferably more than 6 liters in capacity. Consequently, the humanoid robot 1 may incorporate a battery pack with a capacity exceeding 2.5 kWh, which may provide an operational runtime of over 3.5 hours under normal conditions, and preferably more than 4.5 hours, and most preferably more than 6 hours. In some implementations, the torso 16 may adopt a quasi-trapezoidal prism configuration, wherein its front surface is smaller than its back surface, with angled side shrouds connecting these two sections. This geometric design may enhance the range of motion of the robot 1, particularly by improving its ability to reach across its own body.

### 3. Arm Assemblies

The arm assemblies include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the arm assembly may incorporate features such as hard-stops, cooling channels, heat sinks, or other materials, structures, components, or assemblies described herein. For example, a heat pipe may extend from the hand to the lower forearm. Furthermore, the wrist 50 may include a quick-release mechanism that enables the interchange of different end-effectors or tools. Moreover, the housing of each component may be designed with internal reinforcement structures, may be made from various materials (e.g., metal alloys or advanced materials like carbon-fiber-reinforced polymers).

### 4. Leg Assemblies

The leg assemblies 6 include joints between the components that may include interfaces, which are selected to provide high torque transmission efficiency and precise alignment, and may include components such as splined shafts, polygon couplings, Oldham couplings, bellows couplings, jaw couplings, universal joints, magnetic couplings, or flexure couplings. Additionally, the components of the leg assembly may incorporate features such as hard-stops, cooling channels, heat sinks, or other materials, structures, components, or assemblies described herein. For example, a heat pipe may extend from the knee to the shin 84. Furthermore, the talus 88 may include a quick-release mechanism that enables the interchange of a different foot 92. Moreover, the housing of each component may be designed with internal reinforcement structures, may be made from various materials (e.g., metal alloys or advanced materials like carbon-fiber-reinforced polymers).

To enhance the stability and adaptability of the humanoid robot 1, the leg assemblies 6 may incorporate advanced sensing and control systems, as well as comprehensive protective systems. For instance, force sensors located in the feet 92 and ankles may provide real-time feedback on ground contact forces and pressure distribution. This data may be used by the control system of the humanoid robot 1 to make rapid adjustments in order to maintain balance, especially when moving on uneven or dynamic surfaces. Inertial measurement units (IMUs) positioned in the leg assemblies 6 and the pelvis 64 may also provide crucial information on the orientation and acceleration of each leg segment, thereby allowing for the precise control of leg positioning during movement.

b. Mechanical and Electrical Architecture

The mechanical and electrical architecture 1.2 may be embodied as any combination of hardware, software, and circuitry that enables the humanoid robot 1 to operate and perform physical functions in response to electrical charges or electrical signals. As illustrated comprehensively in additional figures herein, the robot 1 is composed of a plurality of assemblies and components that are specifically arranged to emulate or generally resemble human anatomical structures and their functional characteristics. A humanoid form is advantageous because it enables the robot 1 to execute a wide range of general tasks that are typically performed by humans, such as walking between different locations, handling and moving objects, and retrieving items from various positions and orientations. Non-humanoid forms (e.g., wheeled robots or quadrupeds) typically lack the versatility and effectiveness that are required to perform such a diverse array of generalized tasks.

i. Actuators

The actuators 1.2.4 contained within the robot 1 include thirty actuators (J1)-(J16), excluding the end effectors, that are housed within various components of the robot 1 to actuate movement of said components. An additional aggregate total of twelve actuators are in both hands 56 combined. Below is a summary table showing the actuator 1.2.4 reference names and numbers for the thirty actuators (J1)-(J16), the quantity of each, descriptive actuator names used herein for consistency, common corresponding informal actuator names, and associated rotational axes from the high-level configuration of the illustrative embodiment robot 1. Specific actuators in each hand 56 (e.g., six actuators in each hand) are not individually included in the below table

TABLE 1

| | | Actuator | Informal Actuator | |
|---|---|---|---|---|
| Actuator | Qty | Name | Name(s) | Axis |
| (J1) 190 | 2 | arm | primary arm | A₁ |
| (J2) 280 | 2 | shoulder | (none) | A₂ |
| (J3) 320 | 2 | upper arm twist | upper arm x, upper arm roll | A₃ |
| (J4) 374 | 2 | elbow | arm z, arm yaw, | A₄ |
| | | | lower humerus | |
| (J5) 468 | 2 | lower arm twist | lower arm x, lower arm roll | A₅ |
| (J6) 484 | 2 | wrist flex | wrist/hand y, wrist/hand | A₆ |
| | | | pitch, flick | |
| (J7) 520 | 2 | wrist pivot | wrist/hand z, wrist/hand | A₇ |
| | | | yaw, wave | |
| (J8.1) 120 | 1 | head twist | head no | A_{8.1} |
| (J8.2) 140 | 1 | head nod | head yes | A_{8.2} |
| (J9) 680 | 1 | torso lean | spine x, torso/spine roll | A₉ |
| (J10) 620 | 1 | torso twist | spine z, torso/spine yaw | A₁₀ |
| (J11) 720 | 2 | hip flex | hip y, hip/leg pitch, | A₁₁ |
| | | | forward kick | |
| (J12) 768 | 2 | hip roll | hip x, hip/leg roll, | A₁₂ |
| | | | sideways kick | |
| (J13) 782 | 2 | leg twist | hip z, hip/leg yaw | A₁₃ |
| (J14) 820 | 2 | knee | lower thigh, lower leg y, | A₁₄ |
| | | | lower leg pitch, rear kick | |
| (J15) 860 | 2 | foot flex | foot y, foot pitch, or | A₁₅ |
| | | | first ankle | |
| (J16) 900 | 2 | foot roll | talus, foot roll, foot x, | A₁₆ |
| | | | second ankle | |

It should be understood that in other embodiments, some of these systems, assemblies, components, and/or parts may be omitted, combined, or replaced with alternative systems, assemblies, components, and/or parts.
ii. External Cover Assembly

The illustrative embodiment robot 1 includes various components (e.g., assemblies) with housings 1.2.2 (e.g., to form an exoskeleton) that are designed to protect the operational systems of the robot 1, such as actuators 1.2.4 and electronics assembly 1.2.6, provide structural support, and give form to the robot 1. Said housings 1.2.2 can be comprised of hard or rigid casings that may include internal mounting features designed to support systems in specific locations, structural features engineered to withstand operational loads, and internal and/or external features that allow for interoperation between adjacent components and/or are formed to resemble human features. Some housings 1.2.2 additionally include one or more detachable shells that may overlay a casing to allow access to internal assemblies or to complete the form of the component.

The requirements of the housings 1.2.2 can vary in shape and form based on the individual structural or material requirements for each specific component. While it may be desirable to utilize a particular material for all housings 1.2.2 to create a consistent exterior appearance, fabrication may be complicated by specific structural or operational needs at different locations. It may not be necessary to utilize the same materials in different housings 1.2.2 that experience different load requirements. Various materials may be preferred for a specific housing 1.2.2 based on properties such as strength, toughness, elasticity, weight, and conductivity. Similarly, the complexity of some housing 1.2.2 designs may be better suited for one type of manufacturing process, such as machining, die casting, injection molding, or composite fabrication, over another. Because there is a desire or need to use different materials within different regions and/or use materials that do not have a consistent exterior appearance, the illustrative embodiment robot 1 includes exterior coverings of the exterior covering assembly 1.2.16 that are designed to at least partially hide the housings 1.2.2 under a textile exterior layer that can be easily swapped if damaged, serve to protect internal components from dust and debris, are designed to fit the form of the robot 1 without substantial wrinkling, and/or allow for venting or address thermal considerations at specified locations.

The exterior coverings may have a multi-layered assembly, which may include: (i) an energy-absorbing material that is coupled to the coupling layer, (ii) a coupling layer (e.g., plastic or polymer based), wherein the coupling layer facilitates attachment to, or attachment at, a housing 1.2.2, and/or (iii) an exterior coverings material (e.g., a textile). Alternatively, the multi-layered assembly may omit the coupling layer, the energy-absorbing material, and/or exterior covering material. In each case, the movement of the nearby joint may cause one housing 1.2.2 to impact or crush the energy absorbing layer instead of another housing 1.2.2, thereby mitigating or eliminating structural stress or load on either housing 1.2.2 and/or the respective actuator 1.2.4. Additionally, the energy attenuation members help to reduce pinch points, and/or allow for a more human-like appearance.

### 1. Energy Attenuation Assembly

The energy attenuation assembly may be composed of a plurality of integrated or removable energy attenuation members, such as pads, panels, or bumpers, that are attached to housings 1.2.2 of the robot 1 and/or are positioned within the external covers. Said energy attenuation members may: (i) be attached directly to a particular exterior side of a housing 1.2.2 (e.g., overlie the housing), (ii) surround an exterior of a housing 1.2.2 and not be directly attached (e.g., friction fit), (iii) be attached to the edges of an opening formed in the housing 1.2.2 (e.g., act as a deformational extent of the housing), and/or (iv) be attached to or retained by the exterior coverings.

The disclosed robot 1 includes a torso energy attenuation member, elbow energy attenuation members, and leg energy attenuation members. Additionally, energy attenuation members may be included at the hip, shin, and/or foot. Some or all energy attenuation members may also be omitted. Energy attenuation members can be configured to enhance or alter the shape of the robot 1 without adding substantial weight and to provide a deformable structure with energy absorption properties to protect underlying components.

The energy attenuation members can be made from a wide variety of materials, including: (i) polymers, such as polyethylene foam (PE Foam), ethylene vinyl acetate (EVA) foam, polyurethane foam (including Memory Foam and Open-cell Polyurethane Foam); (ii) rubber foams; (iii) natural foams; (iv) engineered foams; (v) composite and hybrid materials; (vi) expanded polystyrene (EPS); (vii) expanded polypropylene (EPP); (viii) Koroyd®; (ix) D3O®; (x) Poron® XRD; (xi) thermoplastic elastomers (TPE) or thermoplastic polyurethane (TPU); (xii) any other material known to one of skill in the art that accomplishes the desired energy absorption characteristics; (xiii) any combination of the above. Furthermore, the energy-absorbing material may alternatively or additionally include other structures of said materials, wherein said structures may include lattices and/or repeating units, such as a cube, sphere, cylinder, cone, pyramid, torus, prism, tetrahedron, dodecahedron, octahedron, icosahedron, ellipsoid, paraboloid, cuboid, or hexahedron. It should be understood that the repeating unit or lattice cell may be contained in a specific region or may propagate throughout the entire energy attenuation member. Additionally, the energy attenuation members and/or the assembly may have varying properties, such as thickness, density, C/D ratio, and stiffness. This variation may be arranged in a gradient manner, wherein the energy-absorbing materials transition from softer to firmer layers or regions to provide progressive energy dissipation.

### 2. Exterior Coverings

The exterior coverings, which can include a neck cover, a torso cover, an upper leg cover, a shin cover, a foot cover, a lower arm cover, and a hand cover, are designed not to interfere with the robot's range of motion, to allow access to underlying components, to potentially add indicators to the external surface, and to improve the robot's overall aesthetic appearance. As shown in the figures, a single exterior covering does not extend over all actuators in the robot 1, and typically does not cover more than five actuators at a time. In other words, the exterior covering does not resemble an oversized jumpsuit with a closure running from, e.g., the robot's pelvis to its head region, nor does it include a hood that extends around a substantial portion of the robot's head. Instead, the exterior covering is strategically and tightly fitted in certain regions and may include different inserts (e.g., a different textile) that are positioned between the moving aspects of joints.

Exterior coverings materials of the exterior covering assembly 1.2.16 can be made from one or more textiles and can be customized or selected to reduce wrinkling and to allow for the twisting or movement of the underlying components without restriction or substantial distortion. For example, the exterior coverings materials may be designed to allow the lower arm to twist and rotate from about-120 degrees to about 180 degrees. Additionally, the exterior coverings materials may be selected to allow for the cooling of components, the viewing of indicator lights, or the operation of buttons through said exterior coverings. This provides a substantial benefit over conventional systems that lack these advanced features. It should be understood that this disclosure contemplates using or including exterior coverings materials that: (i) integrate lights from the robot 1 into said exterior covering, and specifically into a textile itself, (ii) may be translucent or temporarily translucent (e.g., based on time or environment), and/or (iii) can be formed (e.g., woven) in a manner that allows light to be transmitted through the textile.

As such, various types of lights (e.g., fiber optic lighting, led strip lights, led rope lights, micro-led string lights, led neon flex, phosphorescent paint, OLED panels (organic light-emitting diode), laser diode lighting, neon tubing, electroluminescent panels, led edge-lit panels, flexible led sheets, flexible OLED strips, inductive electroluminescent displays, laser fiber cables, quantum dot light-emitting displays, phosphor-coated led strips, laser-activated fluorescent materials, electroluminescent paint, laser-illuminated fiber bunches, phosphor-coated electroluminescent (PCEL) materials, smart RGB led strips, light-up silicone tubing (LED or EL-based), laser wire, or other electroluminescent materials such as EL wire, EL tape, or EL film) that are coupled to the humanoid robot 1 may be visible through the exterior coverings material. The exterior coverings material can include reflective yarn or night-luminous yarn that changes its appearance when light is shining on its surface. In other embodiments, a shiny, reflective, iridescent, matte, or textured polyurethane film can be applied to the surface of the exterior coverings material (e.g., a textile) in certain areas to provide an additional reflective effect or for another purpose, such as displaying a logo, pattern, or labels.

The exterior coverings material can also include features to accommodate the thermal considerations of the robot 1. In various examples, the exterior coverings material can be a custom textile that utilize different weaves in different locations to allow for ventilation in specific areas. Additionally, the exterior coverings material can include textiles or threads that are heat-sensitive and change color with a change in temperature. In summary, the exterior coverings may additionally be made from, include, or specifically omit any one or any combination of the following material types: durable materials, flame-resistant materials, waterproof materials, hazard materials, chemical-resistant materials.

Alternatively or additionally, the exterior covering assembly 1.2.16 may include features such as closures (e.g., a zipper that runs a partial or full length of the exterior covering assembly 1.2.16), attachment points, couplers, self-cleaning nanocoatings, thermoelectric materials, photochromic dyes, or electromagnetic shielding layers, as well as modular, quick-release panels or e-textile technology with conductive fibers woven throughout to create a distributed sensor network that is capable of detecting impacts, monitoring joint angles, or even harvesting energy from movement. The exterior covering assembly 1.2.16 may be designed to include inserts (which may also be textiles or may be other materials) that are positioned strategically between moving joint components to further ensure that pivoting motion is not restricted at the joints of the humanoid robot 1. Different textile materials, patterns, knits, weaves, etc. may be incorporated to facilitate movement in specific regions, thereby enhancing the functional dexterity of the robot 1.

iii. Sensors

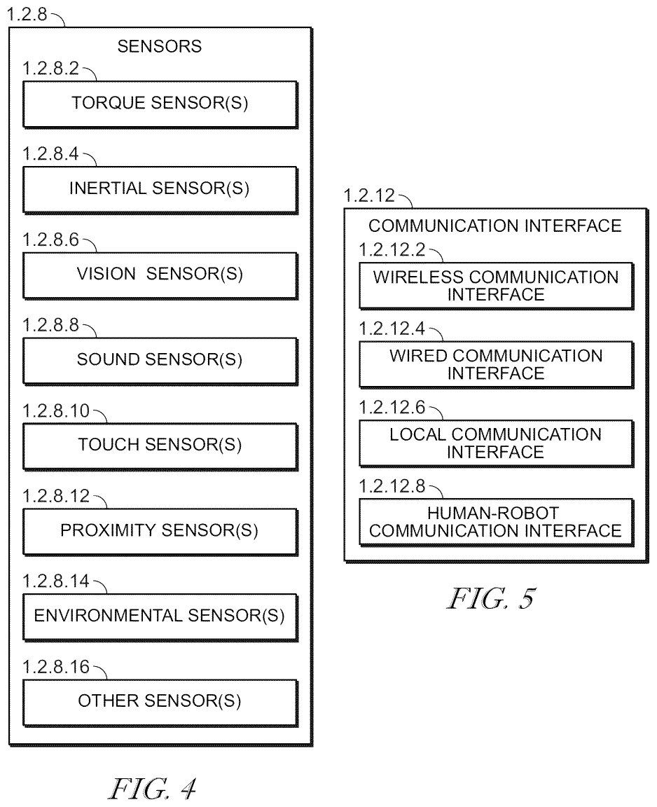

As illustrated in FIG. 4, sensors 1.2.8 may be embodied as any hardware, software, and/or circuitry for providing sensor data indicative of perceived stimuli, conditions, and measurements to enable the humanoid robot 1 to process, reason, and act appropriately (e.g., based on a given task, a set of rules, and/or other constraints). The sensors 1.2.8 may include one or more torque sensors 1.2.8.2, inertial sensors 1.2.8.4, visual sensors 1.2.8.6, auditory sensors 1.2.8.8, touch sensors 1.2.8.10, proximity sensors 1.2.8.12, environmental sensors 1.2.8.14, and other sensors 1.2.8.16. The sensors 1.2.8 may provide sensor data (e.g., torque, inertia measures, audiovisual sensor data, touch data, proximity data, environmental data, etc.) to the compute 1000 processors, further described below, to enable appropriate interaction between the humanoid robot 1 and the environment.

The torque sensors 1.2.8.2 may comprise one or more torque cells that are positioned within the actuators and are designed to measure the amount of force or torque applied to a part of the humanoid robot 1. The measurements may be transmitted to other components of the humanoid robot 1, such as the whole body controller 1550 or one or more controllers 1600, to enable balance, locomotion, manipulation, and handling by the humanoid robot 1.

The inertial sensors 1.2.8.4 may comprise sensors for measuring the motion, position, and orientation of the humanoid robot 1 relative to the environment for purposes of navigation, stabilization, and interaction with the environment and surroundings. For example, the inertial sensors 1.2.8.4 can include one or more accelerometers (e.g., to measure acceleration forces in one or more directions for use in determining changes in velocity and orientation), gyroscopes (e.g., to measure angular velocity for use in tracking rotational movement and maintaining balance), IMUs (e.g., combining the accelerometers and gyroscopes for use in providing comprehensive motion and orientation data), and Global Positioning System (GPS) receivers (e.g., to provide location data based on satellite signals, for use in outdoor navigation and positioning).

The visual sensors 1.2.8.6 may comprise sensors for capturing visual data, including cameras (e.g., red-green-blue (RGB) standard color cameras, grayscale monocular cameras, and stereo cameras (e.g., to capture depth perception)), depth cameras (e.g., depth cameras using technologies such as structured light or time-of-flight to measure distance to objects, Azure® Kinect® depth camera, Intel® RealSense® depth camera, etc.), LIDAR (Light Detection and Ranging) sensors (e.g., to measure distance to objects by emitting laser pulses, analyze the reflections, and provide detailed 2D or 3D maps of the environment), radar (e.g., to detect objects via radio waves and measure distance and speed for use in various applications including navigation and obstacle detection). Visual sensors 1.2.8.6 may also include event-based cameras, which report changes in pixel intensity rather than full frames, offering advantages in speed and data efficiency for dynamic scenes. Examples of said visual sensors 1.2.8.6 include the cameras 108.2.2 and 108.2.4 contained in the head 10.1 of the robot 1.

The auditory sensors 1.2.8.8 may comprise sensors for capturing audio data, including microphones (e.g., to capture audio signals for voice recognition, environmental noise detection, or communication), ultrasonic transducers (e.g., to capture distance measurement and obstacle detection through high-frequency sound waves), spatial audio sensors such as microphone arrays and direction of arrival sensors (e.g., to capture sound from different locations to determine the direction and distance of sound sources for 3D positioning). Auditory sensors 1.2.8.8 could also include specialized acoustic sensors for detecting specific sound patterns, such as the sound of failing machinery or distress calls, further enhancing the robot's environmental awareness.

The touch sensors 1.2.8.10 may comprise sensors for detecting physical contact or pressure applied to the surface of the humanoid robot 1, e.g., to enable tactile feedback, safety and collision avoidance, object handling and manipulation, and interaction with the environment and surroundings. Example touch sensors 1.2.8.10 may include pressure sensors to measure an amount of pressure applied to a surface by the humanoid robot 1, such as capacitive sensors (e.g., to detect touch or proximity through changes in capacitance), resistive sensors (e.g., to detect pressure or touch by measuring changes in resistance), piezoelectric sensors (e.g., to generate an electrical charge in response to mechanical stress or pressure and detect vibrations or impact), force-sensitive resistors (e.g., to change resistance based on the amount of applied force), and optical touch sensors (e.g., to use light beams or infrared to detect touches or proximity). Alternative touch sensors 1.2.8.10 may involve artificial skin technologies that provide a more distributed and nuanced sense of touch, capable of detecting not only contact but also shear forces and temperature changes on the robot's surfaces.

The proximity sensors 1.2.8.12 may comprise sensors for detecting the presence or absence of objects within a given range without necessarily making physical contact with the object, e.g., to provide obstacle avoidance, navigation, and object detection. Example proximity sensors 1.2.8.12 can include ultrasonic sensors (e.g., to measure distance by emitting ultrasonic waves and detecting reflection of the waves for avoiding obstacles and measuring distance) and infrared rangefinders (e.g., to detect, using infrared light, the presence or distance of objects for proximity sensing and simple obstacle detection). Capacitive proximity sensors may also be used as part of proximity sensors 1.2.8.12, particularly for close-range interactions.

The environmental sensors 1.2.8.14 may comprise sensors for measuring various physical parameters of the environment and surroundings to enable the humanoid robot 1 to interact with the environment and surroundings, adapt to changes in the environment and surroundings, and perform a given task. Example environmental sensors 1.2.8.14 can include thermocouples (e.g., to measure temperature by generating a voltage proportional to temperature difference), thermistors (e.g., to measure temperature based on changes in resistance), magnetometers (e.g., to measure magnetic fields for navigation and orientation), light sensors (e.g., to measure intensity of light in the environment), gas sensors (e.g., to detect presence and concentration of various gases and monitor air quality), and humidity sensors (e.g., to measure relative humidity in the air). Other environmental sensors 1.2.8.14 could include barometric pressure sensors for altitude determination or weather prediction, radiation sensors for operation in hazardous environments, or particulate matter sensors for air quality assessment in industrial settings.

iv. Communication Interfaces

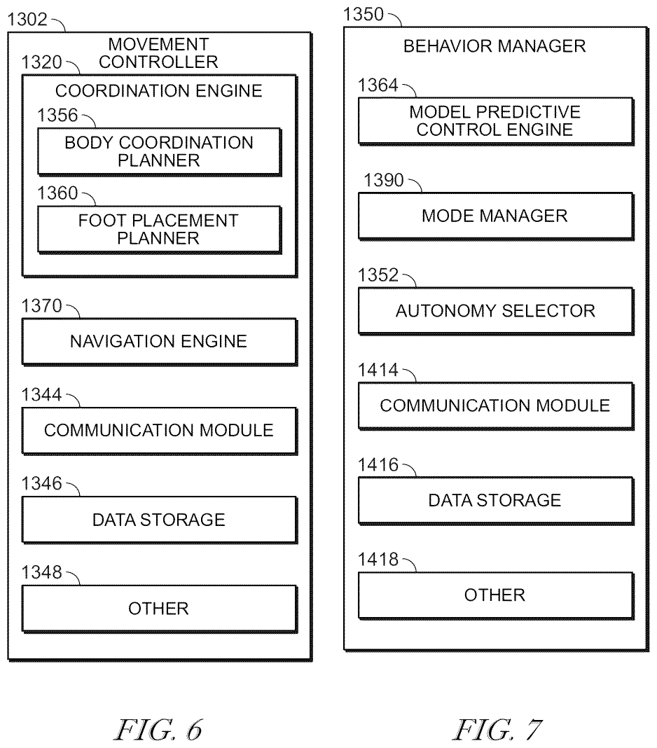

The communication interfaces 1.2.12 may be embodied as any hardware, software, or circuitry to enable the exchange of data, signals, and other forms of communication between different components within the humanoid robot 1, and between the humanoid robot 1 and other systems (e.g., other humanoid robots 2700A-X, the command centers 2750A-X, the remote AI system 2780), and other components and devices interconnected over the networks 2999A-X. Specifically, FIG. 5 shows that the humanoid robot 1 may be configured with a variety of communication interfaces 1.2.12. The communication interfaces 1.2.12 may be embodied as any combination of a communication circuit, device, or collection thereof, capable of enabling communications over a network (e.g., the networks 2999A-X). The communication interfaces 1.2.12 may be configured to use any one or more communication technology (e.g., wired or wireless communications) and associated protocols to effect such communication.

Referring to FIG. 5, examples of communication interfaces 1.2.12 include a wireless communication interface 1.2.12.2 (e.g., Bluetooth®, Wi-Fi®, WiMAX, Cellular (e.g., 3G, 4G, 5G), Zigbee, LoRa (Long Range) and RF (Radio Frequency)), a wired communication interface 1.2.12.4 (e.g., Ethernet, USB, Serial Communication (e.g., RS-232, RS-485), and Controller Area Network (CAN) interface)), a local communication interface 1.2.12.6 (e.g., an I2C (Inter-Integrated Circuit), SPI (Serial Peripheral Interface)), and a human-robot communication interface 1.2.12.8 (e.g., voice recognition systems to enable communication through spoken commands using speech recognition technology, touch interfaces such as touchscreens or physical buttons for direct human interaction with the humanoid robot 1). Alternatively or additionally, the human-robot communication interface 1.2.12.8 may include gesture recognition systems or gaze tracking, allowing for more intuitive and non-verbal interaction with human operators. The communication interfaces 1.2.12 may also include a network interface controller (NIC) (not illustrated), which may also be referred to as a host fabric interface (HFI). The NIC may be embodied as one or more add-in-boards, daughtercards, controller chips, chipsets, or other devices that may be used by the humanoid robot 1 for network communications with remote devices.

v. Data Storage

Referring back to FIG. 2, the data storage 1.2.14 may be embodied as any hardware, software, or circuitry for storing, retrieving, and maintaining data for the humanoid robot 1. More particularly, the data storage 1.2.14 may be embodied as any type of device configured for short-term or long-term storage of data. The data storage 1.2.14 may be embodied as memory devices and circuits, solid state drives (SSDs), memory cards, hard disk drives, USB flash drives, or other data storage devices. The data storage 1.2.14 can be embodied as one or more SSDs that expose internal parallelism to components of the humanoid robot 1, allowing the humanoid robot 1, for example, via the compute 1000, to perform storage operations on the data storage 1.2.14 in parallel.

The data storage 1.2.14 may also include memory devices, which may be embodied as any type of volatile (e.g., dynamic random access memory, etc.) or non-volatile memory (e.g., byte addressable memory) or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards, and similar standards, may be referred to as DDR-based standards and communication interfaces of the storage devices that implement such standards may be referred to as DDR-based interfaces.

The memory device is a block addressable memory device, such as those based on NAND or NOR technologies. A memory device may also include a three dimensional crosspoint memory device (e.g., Intel® 3D XPoint® memory), or other byte addressable write-in-place nonvolatile memory devices. In an embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the device itself and/or to a packaged memory product. For data storage 1.2.14, a hierarchical storage architecture may be employed, using faster, smaller caches for frequently accessed data and larger, slower storage for archival or less critical data, optimizing both speed and capacity.

c. Compute

As illustrated in FIG. 2, the compute 1000 may comprise any combination of hardware, software, and circuitry to perform various computing functions that enable the humanoid robot 1 to operate semi- or fully-autonomously. Specifically, the compute 1000 includes: (i) compute hardware 1010, and (ii) computing architecture 1100. Such functions may include processing long-horizon goals, coordinating with other humanoid robots 2700A-X, processing sensor information, controlling the humanoid robot 1 based on the sensor information and goals, controlling the activation or deactivation of mechanical components, learning, simulating, refining behavioral models, and policy management.

i. Hardware

The compute hardware 1010 may operate as one or more general purpose processors or special purpose processors (e.g., digital signal processors, application specific integrated circuits (ASICs), field programmable gate arrays (FPGAs), etc.) that can be configured to execute computer-readable program instructions stored in the aforementioned data storage devices. Such instructions can be executed to provide controller operations (e.g., to activate or deactivate components of the mechanical and electrical architecture 1.2, etc.). Specifically, the humanoid robot 1 may be configured with a variety of processors such as one or more central processing units (CPUs) 1100 (e.g., x86 CPUs, ARM CPUs, RISC-V CPUs, embedded CPUs such as Internet-of-Things CPUs or mobile CPUs), graphics processing units (GPUs) (e.g., ray tracing GPUs, accelerated computing GPUs, embedded GPUs such as system-on-chip (SoC) GPUs or mobile GPUs), neural network processing units (for example, tensor processing units designed for tensor computations in machine learning tasks; dedicated neural network processing units such as Intel Nervana NNP, Graphcore IPU, IBM TrueNorth, or Qualcomm Cloud AI 100; custom neural network processing units such as Amazon Web Services (AWS) Inferentia, Apple Neural Engine, and Huawei Ascend; and Neuromorphic Neural Network Processing Units such as Intel Loihi or BrainChip Akida), and other processors. For example, the other processors may be embodied as a single or multi-core processor, a microcontroller, or other processor or processing/controlling circuit. In some embodiments, the other processors may be embodied as, include, or be coupled to an FPGA, an ASIC, reconfigurable hardware or hardware circuitry, or other specialized hardware to facilitate the performance of the functions described herein.

ii. Architecture

The computing architecture 1100 includes: (i) a movement controller 1302, (ii) a behavior manager 1350, (iii) a perception system 1420, (iv) a local AI system 1470, (v) a whole body controller 1550, (vi) one or more controllers 1600, and (vii) other subcomponents 1650.

### 1. Movement Controller

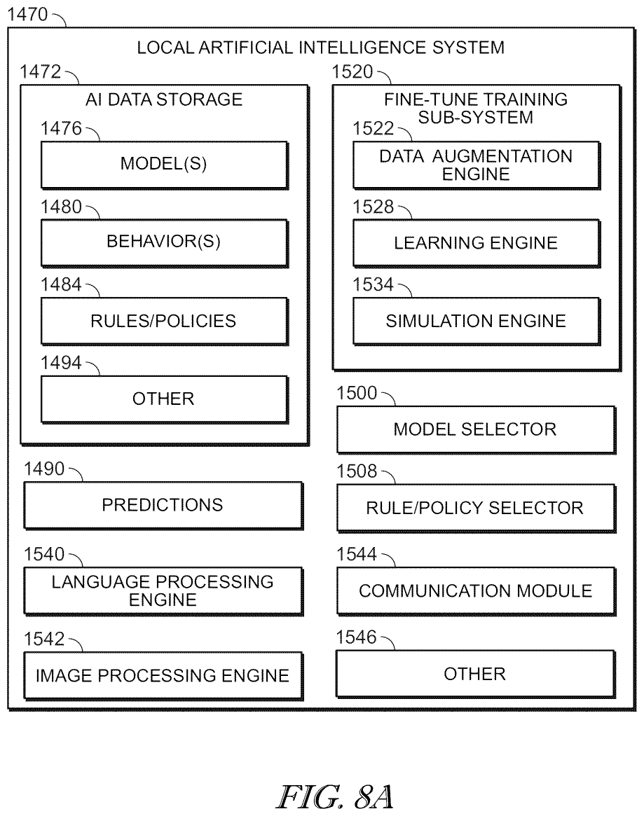

Referring to FIG. 6, the movement controller 1302 may be embodied as any hardware, software, or circuitry to determine a sequence of actions or a path for the humanoid robot 1 to achieve a given goal or complete a given task, in light of a current state, a set of constraints (e.g., the capabilities of the robot 1 and the environment and surroundings of the robot 1), and instructions from another sub-component of the robot 1 or another aspect of the overall architecture 1100. To carry this out, the movement controller 1302 may include a variety of components, such as: (i) a coordination engine 1320, (ii) a navigation engine 1370, (iii) a communication module 1344, (iv) a data storage 1346, and/or (v) other 1348.

The disclosed movement controller 1302 overcomes limitations associated with conventional robotic systems by enabling the robot 1 to: (i) coordinate its body using the body coordination planner 1356 and foot placement planner 1360 based on instructions from the local AI system 1470 and/or remote AI system 2780, (ii) navigate its world by mapping its environment (e.g., SLAM) and predict movement of objects within said environment, and (iii) communicate with its environment. The movement controller 1302 also enables the robot 1 to adapt in real-time to dynamic environments by continuously monitoring the execution of its plans and comparing the expected outcomes with actual results. The movement controller 1302 further solves the technical challenge of efficient resource allocation. By considering the current state of the robot 1, available energy, time constraints, and the relative importance of different goals, the movement controller 1302 optimizes the allocation of the computational and physical resources of the robot 1. Furthermore, the movement controller 1302 can addresses the issue of human-robot collaboration by incorporating models of human behavior and preferences into its decision-making process. This allows the robot 1 to generate plans that are not only efficient from a purely mechanical standpoint but are also intuitive and comfortable for human collaborators.

In an embodiment, the coordination engine 1320 receives task inputs from one or more AI systems 1470, 2780 and provides supplemental information to the whole body controller 1550 regarding the state, configuration, and/or position of the robot 1 within its environment. In particular, the coordination engine 1320 can utilize both the body coordination planner 1356 and the foot placement planner 1360 to control the body placement and foot placement of the humanoid robot 1 based on the inputs from the one or more AI systems 1470, 2780. Specifically, the coordination engine 1320 may break down or override the task inputs from the one or more AI systems 1470 to ensure efficient control of the robot 1 within a space, e.g., during movement such as walking, running, or jumping, to ensure balance, stability, and efficient locomotion of the humanoid robot 1. In other embodiments, the coordination engine 1320 and/or most of the movement controller 1302 may be consumed within the one or more AI systems 1470, 2780.

The navigation engine 1370 may be embodied as any combination of hardware, software, and/or circuitry to map the environment and surroundings based on obtained sensor data (and data that may be obtained from external sources such as other humanoid robots 2700A-X, mapping services, weather services, GPS modules, etc.) and to generate one or more paths. The mapping for the environment by the navigation engine 1370 may then be provided to the one or more AI systems 1470, 2780 to enable said systems to plan the next move or task of the robot 1.

The data storage 1346 may be configured to store navigational data generated by the navigation engine 1370 and/or position data generated by the planners 1356, 1360. This navigational data and/or position data may be then fed back into the one or more AI systems 1470, 2780 to enable said systems to plan the next move or task. This data may be categorized as short-term memory data and/or long-term memory data. For example, the short-term memory data may include said position data, which comprises the positions of the robot 1 over the last predefined amount of time (e.g., 1 minute or 5 seconds, or anytime between). Meanwhile, the long-term memory data may include the navigational data, which comprises maps of every place any robot 1, 2700A-X has ever visited or been. The ability to feed different amounts of short-term memory data and/or long-term memory data into the one or more AI systems 1470, 2780 provides a significant advantage over conventional robots, as it can efficiently limit the data needed to perform the task without requiring unnecessary processing power that could not be performed on a mobile robot 1. It should be understood that the movement controller 1302 may be omitted and/or consumed by one or more models (e.g., RL trained models) that are contained within the local AI system 1470.

### 2. Behavior Manager

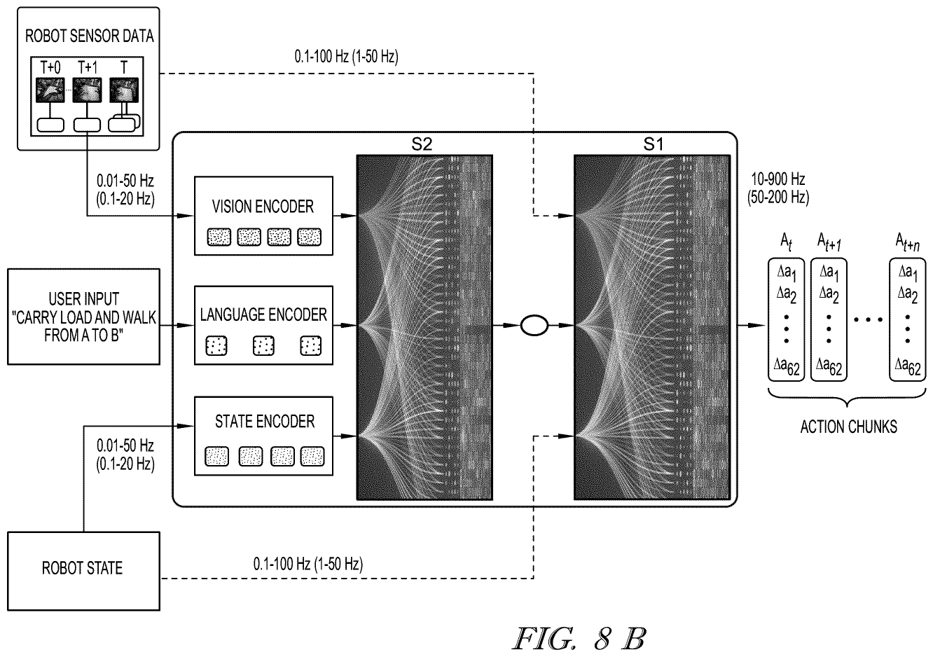

Referring to FIG. 7, the behavior manager 1350 may be embodied as any hardware, software, or circuitry for managing behaviors or actions of the humanoid robot 1 based on a given goal, sensor data, and the environment and surroundings of the humanoid robot 1. To accomplish this, the behavior manager 1350 includes: (i) at least one model predictive control engine 1364, (ii) a mode manager 1390, (iii) an autonomy selector 1352, (iv) a communications module 1414, (v) a data storage 1416, and (vi) other modules or components 1418. The disclosed behavior manager 1350 solves several critical technical issues in the field of robotics. One technical issue solved by the behavior manager 1350 is the integration and coordination of multiple modules within a single robotic system. The behavior manager 1350 also solves the technical issue of ensuring that the behaviors of the robot 1 are executed in the correct order, which prevents conflicts and ensures smooth transitions between different actions or states. For example, the manager 1350 might ensure that a “stand up” behavior is completed before a “walk” behavior is initiated, or that an “object recognition” behavior is performed before an attempt to grasp an object is made.

The model predictive control engine 1364 aids in predicting future states of the humanoid robot 1 based on its current state, and/or making decisions to optimize behavior and performance over a given time period. The MPC engine 1364 may select from one or more predefined or learned actions for the humanoid robot 1 to take in response to various stimuli observed by the humanoid robot 1 (e.g., via sensors 1.2.8) and other factors such as assigned tasks to perform. For example, such MPC engine 1364 may select from or utilize different predefined routines or modes to accomplish path planning, obstacle avoidance, object grasping and manipulation, human-robot interaction, task planning and execution, decision making, coordination with other humanoid robots 2700A-X and machines 2710A-X, and safety and regulatory compliance behaviors. Over time, the MPC engine 1364 may communicate with the local AI system 1470 to enable the MPC engine 1364 to refine its selections based on learning algorithms that identify predefined or learned actions for the humanoid robot 1 based on the given tasks, scenarios, and constraints.

Meanwhile the mode manager 1390 can manage modes of the robot 1. Specifically, the mode manager 1390 is configured to select an appropriate mode or set of modes given a specified task, scenario, or constraint. For example, the mode manager 1390 may select between a power mode, a standby mode, a standing mode, a sitting mode, a movement mode (e.g., running, walking, jumping, hovering, etc.), a falling mode, a learning mode, a diagnostic mode, an emergency mode, etc. Over time, the mode manager 1390 may collaborate with the local AI system 1470 to refine its mode selection based on learning algorithms.

The autonomy selector 1352 may be configured to manage autonomous features of the behavior manager 1350. For example, an operator may, through the autonomy selector 1352, configure a level of autonomy of the humanoid robot 1 (e.g., such that the humanoid robot 1 operates manually, in which the operator may remotely control the operation of the robot 1, semi-autonomously, or fully autonomously). In an embodiment, the operator may, through the autonomy selector 1352, specify certain features to be conducted autonomously and others to, e.g., perform a repetitive task without any form of AI/ML-based behavior or to require some form of manual input for operation.

The communication module 1414 may be embodied as any combination of hardware, software, or circuitry to enable components of the behavior manager 1350 to communicate with one another and with other components of the humanoid robot 1 (such as of the compute 1000). The data storage 1416 may be any data storage device or partition on a data storage device for short-term or long-term storage of behavior controller data (e.g., event logs, movement data, training data, navigation logs, mapped area and path data, etc.). Other components 1418 may pertain to other hardware, software, and/or circuitry not previously discussed above relative to the behavior manager 1350, such as cache data, data aggregation modules, data augmentation modules, body part component health management, or calibration data management. It should be understood that the behavior manager 1350 may be omitted and/or consumed by one or more models (e.g., RL trained models) that are contained within the local AI system 1470.

### 3. Perception System

The perception system 1420 may be embodied as any hardware, software, or circuitry for obtaining audiovisual data (e.g., from sensors 1.2.8) and providing this data to the local AI system 1470 for executing AI-based vision techniques (e.g., object detection, image classification, segmentation, object tracking, facial recognition, scene understanding, depth estimation, anomaly detection, reinforcement learning etc.) to generate, from the audiovisual data, one or more three-dimensional (3D) images. The images may further be annotated with contextual data (e.g., foreground/background information, object classification data, labeling, etc.) for additional processing by the local AI system 1470 and the behavior manager 1350. It should be understood that the perception system 1420 may be omitted and/or folded into the local AI system 1470.

4. Local AI system

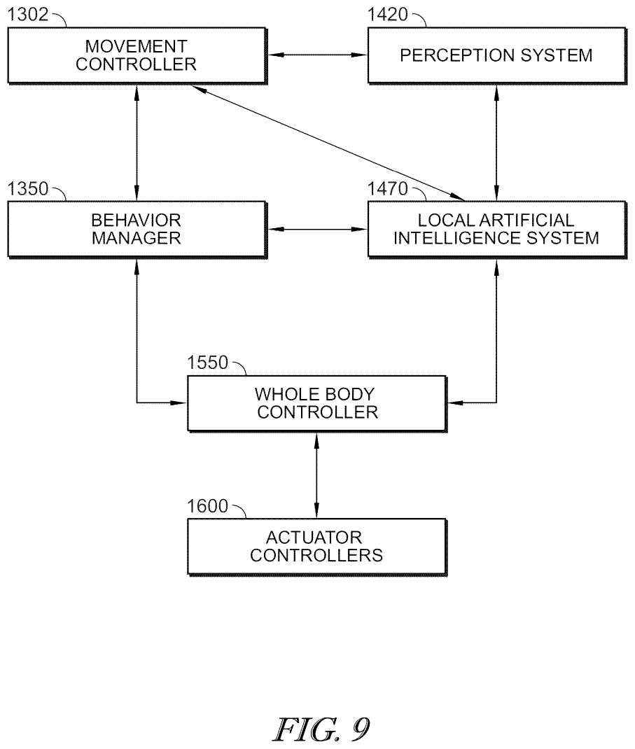

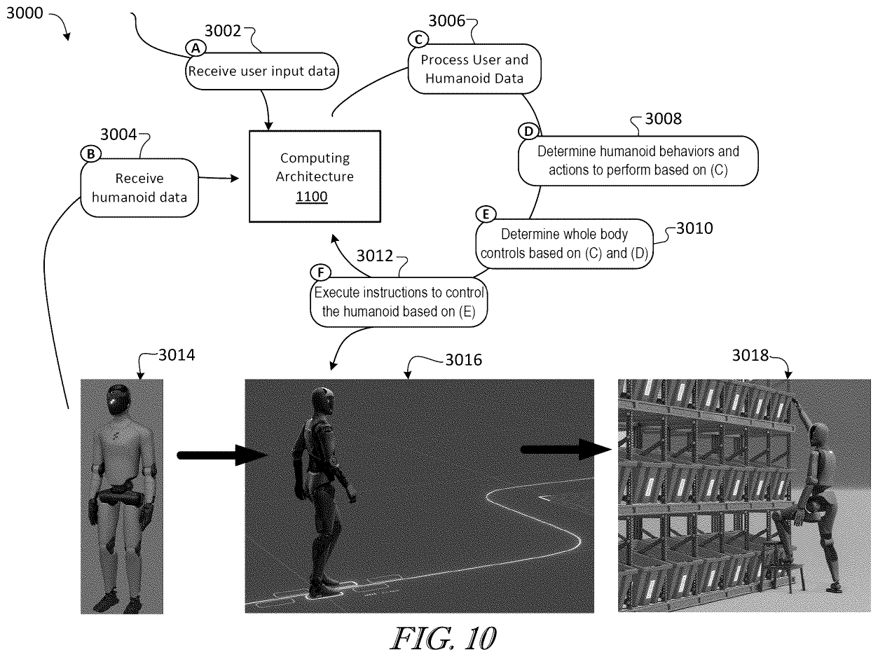

The local AI system 1470 may be embodied as any combination of hardware, software, or circuitry to drive semi- to fully-autonomous perception, learning, and behavior by the humanoid robot 1. The local AI system 1470 may: (i) include modes or architectures that are run on the disclosed local AI system 1470 only, (ii) include models or architectures where a portion of the model or architecture is run on the local AI system 1470 and another portion of the model or architecture is run on the remote AI system 2780, and (iii) include modes or architectures that are run on the disclosed remote AI system 2780 only. The local AI system 1470 is described in further detail relative to FIG. 8.

Referring now to FIG. 8, the illustrative local AI system 1470 may include a variety of components, including an AI data storage 1472, predictions 1490, a model selector 1500, a rule and policy selector 1508, a training sub-system 1520, a language processing engine 1540, an image processing engine 1542, and a communication module 1544. However, it should be understood that the local AI system 1470 may interact with and form part of each and every other component (e.g., movement controller 1302, behavior manager 1350, perception 1420, whole body controller 1550, and controllers 1600). As such, in some embodiments, the compute 1000 may only include or primarily include the local AI system 1470. In other words, the local AI system 1470 may not be considered a separate component or system, but instead an integral component of other systems contained within the compute 1000. Thus, a primary technical issue solved by the local AI system 1470 is the challenge of real-time, context-aware decision-making. Traditional robotic systems often rely on pre-programmed responses or remote processing, which can lead to delays or inappropriate actions in dynamic situations. The local AI system 1470 overcomes this limitation by enabling rapid, localized processing of sensory inputs and the immediate generation of appropriate responses.

Another technical challenge addressed by the local AI system 1470 is the integration and interpretation of multi-modal sensory data. The humanoid robot 1 is equipped with various sensors, including visual, auditory, tactile, and proprioceptive systems. The AI system 1470 efficiently fuses these diverse data streams in real-time, creating a comprehensive and coherent representation of the state of the robot 1 and its environment. This integrated perception allows for more nuanced and accurate interactions with the physical world and human collaborators. The local AI system 1470 also solves the technical issue of adaptive learning and continuous improvement. Unlike static systems, this local AI system 1470 can modify its behavior based on experience and feedback. It employs advanced machine learning algorithms, potentially including deep reinforcement learning and online learning techniques, to continuously refine its decision-making processes. This adaptability allows the robot 1 to improve its performance over time, learn new tasks with minimal explicit programming, and adjust to changes in its operational environment or physical capabilities. A further technical challenge resolved by the local AI system 1470 is the efficient management of the limited computational resources of the robot 1. The AI system 1470 implements sophisticated task prioritization and resource allocation algorithms, ensuring that critical processes receive adequate computational power while less urgent tasks are managed efficiently. This dynamic resource management enables the robot 1 to maintain optimal performance across a wide range of operational scenarios, from simple repetitive tasks to complex problem-solving situations.

The AI data storage 1472 may further include one or more models 1476, behaviors 1480, rules and policies 1484, and other data 1494. The models 1476 may comprise one or more AI/ML-based models to perform the functions described herein, such as observing, reasoning, and learning behaviors based on the environment and surroundings and performing simple to complex tasks given the environment and surroundings, e.g., similar to the models 2902 of the remote AI system 2780. The illustrative model selector 1500 is configured to select an appropriate model or set of models 1476 given a specified task, scenario, or constraint. For example, the model selector 1500 may select a given model based on considerations such as the task, a cost to perform the task, performance efficiency, the environment and surroundings, resource management, or the current health status of the humanoid robot 1 or its components. Over time, the model selector 1500 may be refined based on learning algorithms that identify efficient models 1476 for given tasks, scenarios, and constraints. In an embodiment, the model may be selected in response to operator input as an alternative to automated selection. This may be useful, e.g., during the initialization of the humanoid robot 1.

The illustrative rule and policy selector 1508 may be configured to select one or more of the rules and policies 1484 that are stored in the AI data storage 1472 to be enforced during the operation of the humanoid robot 1, e.g., based on operator input given a context, environment, compliance and regulatory jurisdiction, safety considerations, and the like. In an embodiment, the rule and policy selector 1508 may automatically learn efficient methods for adapting to selected rules and policies over time.

The language processing engine 1540 may be embodied as any combination of hardware, software, or circuitry for obtaining, parsing, interpreting, and understanding natural language directives and concepts, and also for generating natural language speech. For example, the language processing engine 1540 may be configured to translate speech-to-text and text-to-speech. The image processing engine 1542 may be embodied as any combination of hardware, software, or circuitry for performing object detection, image classification, segmentation, object tracking, facial recognition, scene understanding, depth estimation, anomaly detection, or reinforcement learning on input visual data (e.g., as obtained by sensors 1.2.8 such as cameras or in preloaded training data).

The training sub-system 1520 may be embodied as any hardware, software, or circuitry configured to refine models 1476 and behaviors 1480 based on observed data and training data. The training sub-system 1520 may include a data augmentation engine 1522, a learning engine 1528, and a simulation engine 1534. The data augmentation engine 1522 may be embodied as any hardware, software, or circuitry configured to increase the size and diversity of training data, similar to the data augmentation engine 2782 of the remote AI system 2780. The learning engine 1528 may be embodied as any hardware, software, or circuitry for training the AI models 1476, given a set of rules and policies 1484, behaviors 1480, and training data, similar to the training engine 2790 of the remote AI system 2780. The simulation engine 1534 may be embodied as any hardware, software, or circuitry for executing one or more of the AI models 1476 in a virtualized simulation environment to simulate and analyze aspects of the humanoid robot 1, such as kinematics, sensor behavior, robot 1 behavior, and anomalies, similar to the simulation engine 2800 of the remote AI system 2780. Compared to the remote AI system 2780, the AI fine-tuning conducted by the local AI system 1470 may be localized to the specific humanoid robot 1, which can be advantageous in situations such as those where the humanoid robot 1 is configured to perform a specific task.

The other 1546 may include a communications module that is embodied as any combination of hardware, software, and/or circuitry to enable components of the local AI system 1470 to communicate with one another and with other components of the humanoid robot 1 (such as of the compute 1000). It should be understood that the controllers may be omitted and/or consumed by one or more models (e.g., RL trained models) that are contained within the local AI system 1470.

### 5. Whole Body Controller

The whole body controller 1550 may be embodied as any combination of hardware, software, or circuitry for receiving information from the behavior manager 1350 or the local AI system 1470. The whole body controller 1550 may thereafter send the information to other components of the compute 1000. For example, the whole body controller 1550 may transmit joint torque data, which is data pertaining to rotational forces exerted at “joints” of the humanoid robot 1, to the controllers 1600. It should be understood that the whole body controller 1550 may be omitted and/or consumed by one or more models (e.g., RL trained models) that are contained within the local AI system 1470.

The controllers 1600 may be embodied as any combination of hardware, software, and/or circuitry for transmitting joint torque data to the actuators 1.2.4, e.g., to extend and retract parts (such as arms, hands, fingers of the humanoid robot 1). The controllers 1600 may also infer joint torque and angle data received from other sensors 1.2.8, such as IMUs mounted on a given “body part.” In some embodiments, the joint torque and angle data may be measured using rotary position sensors, optical reflection, or other methods. The whole body controller 1550 may also incorporate advanced control strategies, such as passivity-based control or adaptive control, to ensure stability and robustness in the presence of uncertainties or external disturbances. It should be understood that the controllers 1600 may be omitted and/or consumed by one or more models (e.g., RL trained models) that are contained within the local AI system 1470.

### 6. Other

Other components 1650 of the compute 1000 may include components not discussed above relative to the compute 1000, such as power management modules (e.g., to manage battery pack health, manage power usage profiles, etc.) and calibration modules (e.g., to ensure that actual kinetic movements of the humanoid robot 1 align with the expected kinetic movements determined based on calculations). The humanoid robot 1 may include other components 1.2.18, which can encompass components that do not necessarily fall within the aforementioned mechanical and electrical architecture 1.2, or compute 1000. For example, the other components 1.2.18 may include safety systems and mechanisms, emergency override systems, or ports for connecting peripheral devices.

### E. HUMANOID INTERACTIONS

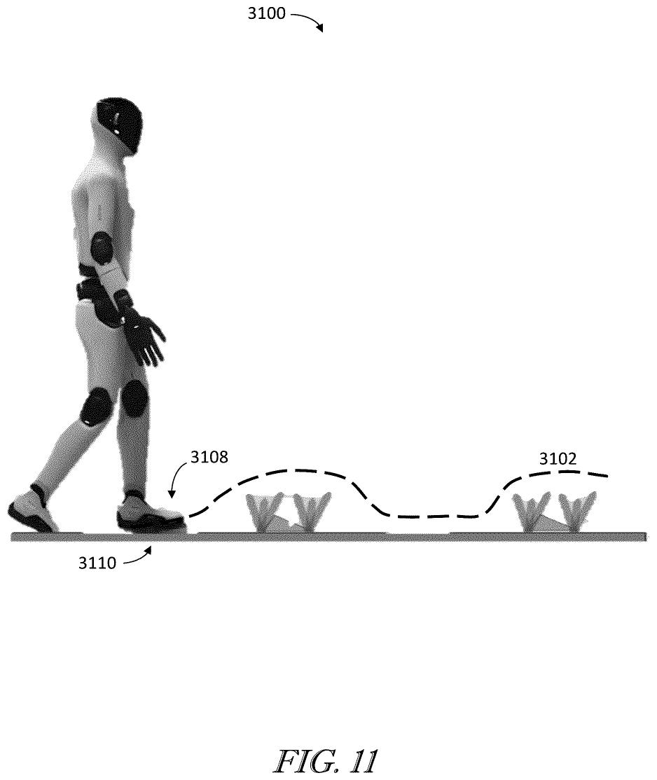

FIG. 9 depicts a diagram illustrating interactions between components of the humanoid robot 1 during its operational state. Upon startup of the humanoid robot 1, the humanoid robot 1 may be in a standby mode or may otherwise remain idle in an initial position (e.g., standing, sitting, lying down, in a stowed configuration for transport, etc.). The humanoid robot 1 may initialize and activate its suite of sensors 1.2.8, which may include inertial measurement units (IMUs), joint encoders, force-torque sensors, cameras (monocular, stereo, or depth-sensing), Light Detection and Ranging (LIDAR) units, RADAR units, ultrasonic sensors, and other perception devices that obtain data in relation to the environment and surroundings of the humanoid robot 1, as well as its own internal state, including positional data, audiovisual data, thermal data, and the like. The movement controller 1302 may be configured to obtain processed environmental data from the perception system 1420, thereby determining the location and orientation (pose) of the humanoid robot 1 within a world model of said environment.

The environmental data, along with the internal state data of the humanoid robot 1, can be fed into: (i) the local AI system 1470 and (ii) the behavior manager 1350. The local AI system 1470 can then, for example, convert speech to text in order to obtain long-horizon goals, wherein said local AI system 1470 can subdivide these long-horizon goals into a structured sequence of one or more sub-goals or tasks. The local AI system 1470 can then check with the behavior manager 1350 to confirm that the humanoid robot 1 is in the correct state for performing the first sub-goal or task. Once the state of the humanoid robot 1 is confirmed, or the state of the humanoid robot 1 is changed to be in the appropriate state, the local AI system 1470 can determine the specific movements and actions to perform for a given specified task. For instance, using a Helix architecture that is shown in FIG. 8B, the local AI system 1470 (as a high-level policy, S2) may process the task and sensor data to generate abstract information that is provided to a semantic latent vector, which encodes the intent of the action. This information is passed through the said latent vector and into a reactive policy (S1). The reactive policy (S1) may then communicate the detailed movement or action information, such as end-effector trajectories, impedance control parameters, or desired joint velocities, to the whole body controller 1550, which in turn generates joint torque data and transmits this data to the actuator controllers 1600 to effect activity in the actuators 1.2.4 and cause the planned movement or action to be performed. In one variation, the behavior manager 1350 interfaces with a two-layer control stack in which a reduced-order predictive planner provides step or foot placement targets and a task-space quadratic program in the whole body controller 1550 enforces rigid-body dynamics and friction while tracking the commanded tasks.

Each of the interacting components may provide feedback information to each other as the movements or actions are being performed, forming a closed-loop control system. For example, the perception system 1420 may relay an indication to the movement controller 1302 that a given task is complete based on audiovisual data, such as confirming an object has reached a target pose or recognized state. As another example, the behavior manager 1350 may be in continuous communication with the whole body controller 1550 to ensure that the movement and positioning of the humanoid robot 1 are as instructed and/or planned by the local AI system 1470 by monitoring state error or tracking error. As yet another example, the local AI system 1470 may continuously receive data from the perception system 1420, the movement controller 1302, the behavior manager 1350, and the whole body controller 1550 and use this data to refine and optimize the currently executing model given present configurations, conditions, and constraints. It should be understood that the movement controller 1302, behavior manager 1350, perception system 1420, whole body controller 1550, and/or actuator controllers 1600 may be omitted, combined, or replaced in some embodiments, such as by an end-to-end neural network policy. To maintain consistency across such alternatives, each module that assumes control of another module maps commands and states to a common reference frame and shared timing base to avoid contradictory coordinate or timing conventions.

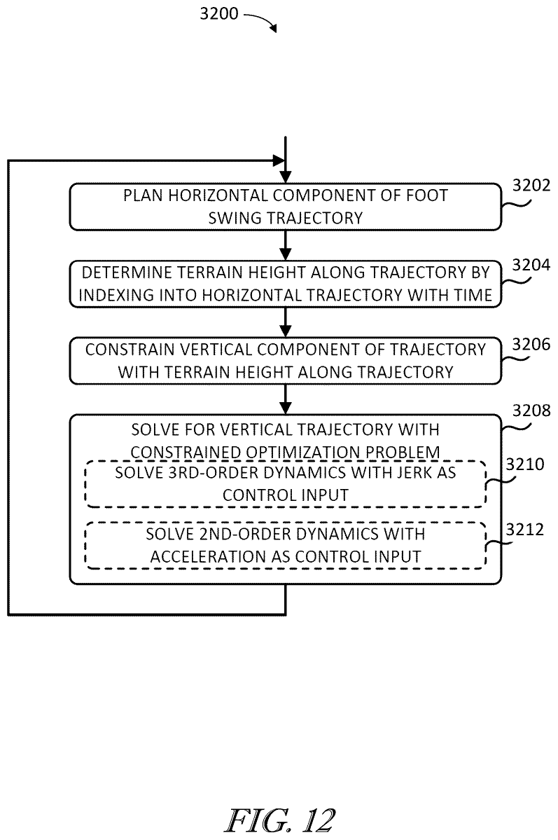

Referring now to FIG. 10, the humanoid robot 1, in operation and via the computing architecture 1100, may execute a method 3000 for operating a humanoid robot 1 to perform a given task. Although the method 3000 is described sequentially herein, one of skill in the art will recognize that some steps may be performed out of order, and further, some steps can be carried out concurrently relative to one another.

As shown, the method 3000 begins in step 3002, in which the computing architecture 1100 receives user input data, e.g., from an operator for a given worksite or command center issuing directives to humanoid robots at the worksite. The user input data may include a selection of an operational mode, one or more behaviors, rules and policies, and models for carrying out a given directive. The user input data may also include a specification of a long-horizon goal or set of tasks received from a plurality of modalities. For example, the user input may be a language-based instruction, such as a voice command or text string, which demands natural language understanding. Alternatively, the input may include a stream of control data generated by a teleoperation device, including but not limited to a wearable teleoperation suit, a haptic feedback glove, a virtual reality (VR) controller, a joystick, or a game controller, providing direct kinematic or dynamic commands for the humanoid robot 1.

In step 3004, the computing architecture 1100 receives humanoid data relating to a current state of the humanoid robot 1, which may include its center of mass position, joint angles, joint velocities, actuator temperatures, and contact states. In this example, assume that the humanoid robot 1 is standing in a stationary position (as depicted in graphic 3014). In step 3006, the computing architecture 1100 processes the received user input data and humanoid data. Assume for this example that the user input data includes a long-horizon goal to obtain a part stored in a specified box located on the top of a specified shelf. The computing architecture 1100 may analyze the user input data within the context of the current state provided in the humanoid data. For example, language-based instructions may be processed by the AI systems 1470, 2780 using the Helix model, Large Language Models (LLMs), or any other vision-language-action models, to interpret semantic intent and ground the content of the goal to the perception of the environment by the humanoid robot 1. The system may then perform decision making algorithms given the current state and specified constraints, configurations, and other factors identifiable in the user input data and the humanoid data. This initial processing stage normalizes the intent of the user into a standardized command format, irrespective of the input modality, for subsequent action generation. In some implementations, the standardized command format defines task goals, safety bounds, and timing windows so that a downstream predictive planner can compute footstep sequences and body targets without ambiguity.

Upon processing the user input, one possible method for action generation involves a direct inference pathway utilizing an AI module, such as a visuomotor model or a comprehensive vision-language-action (VLA) model (e.g., the Helix architecture) from the AI systems 1470, 2780. This AI module can be configured to receive and fuse multiple data streams concurrently: the standardized user command, real-time sensory data including vision data from one or more camera sensors of the humanoid robot 1, and internal robot state data, such as proprioceptive information detailing current joint angles and velocities. By processing these fused inputs through a trained neural network, such as a transformer-based network or diffusion policy, the model directly generates a sequence of robot action commands. These commands can be sufficiently low-level to directly instruct the whole-body controller 1550, thereby bypassing the need for an explicit, multi-stage planning and optimization architecture for certain reactive tasks. As a complementary path, a library of vetted motion primitives may be selected and parameterized from the same fused inputs and then tracked by the whole body controller 1550 with torque commands produced by actuator controllers 1600.

Alternatively, the computing architecture 1100 may employ a hierarchical planning and control architecture. Following the initial interpretation of the user input, the command is routed to a high-level task planner, such as the movement controller 1302. The movement controller 1302 can be configured to decompose the primary command into a sequence of executable subtasks, plan navigational paths through an environment (e.g., using A* or RRT algorithms), and allocate system resources. The output of this planning can be a strategic sequence of objectives, which is then passed to the behavior manager 1350 for execution. The behavior manager 1350 may then engage its model predictive controller (MPC) engine 1364 to perform high-level control and optimization. Specifically, the MPC engine 1364 may utilize a predictive model of the dynamics of the humanoid robot 1, such as the linear inverted pendulum model (LIPM), a single rigid body model (SRBM), or a centroidal dynamics model, to forecast the state of the humanoid robot 1 over a future time horizon. It then solves an optimization problem at each time step to generate an optimal trajectory for the center of mass (COM) of the humanoid robot 1 and a sequence of discrete footstep placements that satisfy stability constraints, such as keeping the zero moment point (ZMP) within the support polygon, while progressing toward the subtask goal provided by the movement controller 1302. The output of the MPC engine 1364 may not be direct joint commands, but rather a set of task-space trajectories that define the intended motion. These trajectories can then be communicated to the low-level whole-body controller 1550, which can utilize inverse kinematics or whole-body impulse control (WBIC) to compute the precise joint torques and angles needed to realize the planned motion, thereby actuating the limbs of the humanoid robot 1 to execute the walking behavior or other actions, as laid out in more details in the following steps. In a two-layer configuration, the MPC engine 1364 can act as a discrete-time foot placement planner with fixed or bounded step timing, while the whole body controller 1550 solves a task-space quadratic program over joint accelerations, contact forces, and torques that enforces rigid-body dynamics with a friction-pyramid model and balances task tracking and effort.

In step 3008, the computing architecture 1100 may determine humanoid behaviors and actions to perform based on the processed user input data and humanoid data. For example, once the computing architecture 1100 understands the long-horizon goal, the computing architecture 1100 may subdivide the goal into tasks performable by the humanoid robot 1, such as identifying the shelf, identifying the location of the box on the shelf, generating a path and trajectory for navigating to the shelf, walking toward the shelf, grasping the box, setting the box on a surface, and searching for the part within the box. The tasks may be further subdivided into more discrete movements, such as moving a given body part, like an end-effector or manipulator, at a specified angle, velocity, or orientation. In certain embodiments, foothold feasibility is computed from elevation maps segmented into planar regions, with steppable convex polygons passed as constraints to the foot placement planner 1360 and the MPC engine 1364.

In step 3010, the computing architecture 1100 may determine whole body controls based on the processed data and the determined behaviors and actions. For example, the computing architecture 1100 may map each task to a given sequence of actions to be performed by the humanoid robot 1, which in turn may be translated into control inputs like joint torque data, joint position targets, and other kinetic information to be sent to the actuators 1.2.4 to achieve performance and completion of each task. In step 3012, the humanoid robot 1 executes the instructions to control the humanoid robot 1 based on the whole body controls. The instructions may be converted into electrical signals that are transmitted to the actuators 1.2.4 to cause the appropriate movement, such as movement along a path and trajectory as depicted in graphic 3016. The whole body controller 1550 may use a prioritized task formulation that reduces weight tuning interference among balance, swing-foot, and posture tasks while honoring contact constraints and joint limits.

In an embodiment, as the humanoid robot 1 performs the specified tasks, the computing architecture 1100 continues to collect and process sensor data, which can be used in learning and identifying additional tasks or subtasks to be performed. Continuing the present example, while moving along the path, the humanoid robot 1 may identify (e.g., based on visual sensor data and object recognition techniques, such as convolutional neural networks or vision transformers, applied to the visual sensor data) a step stool for accessing the top shelf where the box containing the part is located. The computing architecture 1100 may perform additional decision making techniques on the newly observed data (e.g., to determine whether using the stepstool is beneficial given current constraints or configurations for the humanoid robot 1) and determine additional behaviors and actions to perform, such as picking up the step stool, placing the step stool in front of the shelf, and climbing the step stool to reach the box on the shelf, as depicted in graphic 3018. In a variation, step timing and step length may adapt when posture variables or velocity references cross guard bands, with event triggers that command swing initiation when a stance foot leaves a predefined region relative to the hip.

### F. DD

### G. Optimizing Foot Trajectories

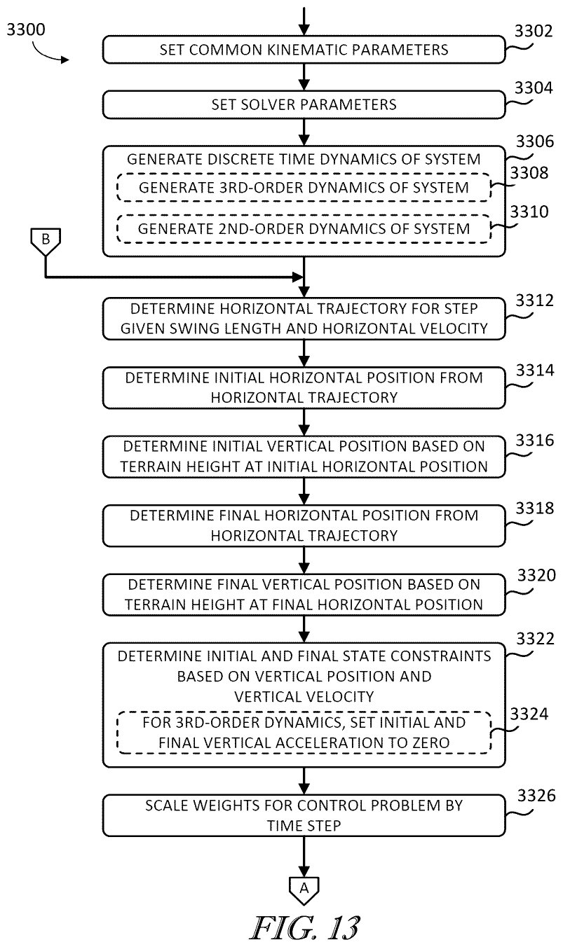

Referring now to the diagram 3100 of FIG. 11, in operation, the foot placement planner 1360 controls movements of components of the humanoid robot 1 to follow a planned foot trajectory 3102 while simultaneously attempting to satisfy a variety of other kinematic and dynamic constraints, such as hand movement limits, self-collision avoidance, and controlling desired body pose. From a nominal plan, such as a straight line path, the foot placement planner 1360 determines the joints of the humanoid robot 1 to generate a dynamically feasible foot trajectory 3102. A dynamically feasible foot trajectory 3102 is one that adheres to the physical constraints and laws of motion given the configuration, mass, and inertia of the humanoid robot 1, thereby ensuring the humanoid robot 1 maintains balance and stability throughout the motion. Parameters associated with the actions performed by the humanoid robot 1 and defined by the foot trajectory may be further defined in terms of desired contact force(s) 3108, contact location(s) 3110, contact orientation(s), and contact duration. The foot placement planner 1360 operates to resolve a stack of possibly competing constraints-which may include tasks related to terrain limits, kinematic reachability, and stability margins-into the single dynamically feasible foot trajectory 3102. This resolution provides a robust and executable plan for subsequent motion execution components. In some embodiments, elevation maps from the perception system 1420 are segmented into planar patches and converted into steppable convex polygons that constrain the touchdown set for trajectory generation.

a. Optimization Method

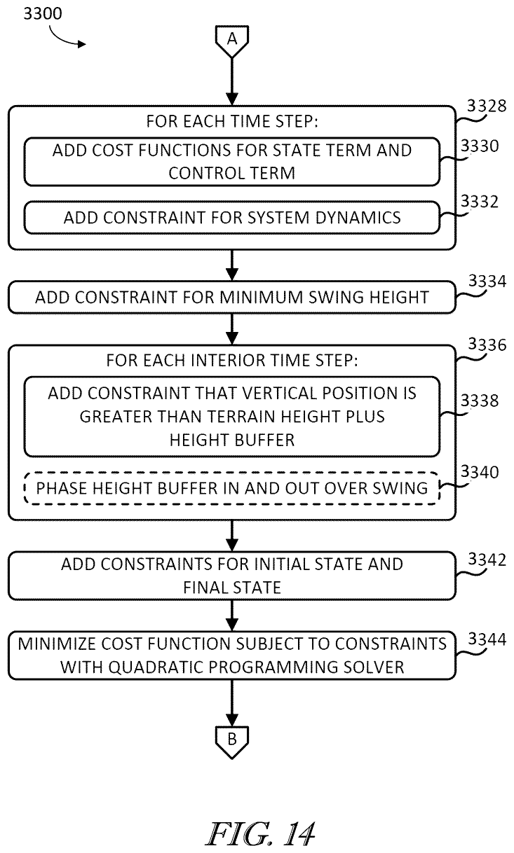

Referring now to FIG. 12, flowchart 3200 illustrates a method for optimizing foot trajectories to provide the humanoid robot 1 with a low-cost bipedal locomotion capability. The method 3200 may be executed locally on the humanoid robot 1 by the computing architecture 1100, or by a remote computing device (e.g., at the command center 2750), a combination of local and remote computing devices, and/or any other combination of one or more other computers, servers, and/or computing devices. At a high level, the method for optimizing foot trajectories involves the computer or computing device: (i) determining a horizontal component of a single footstep (block 3202), (ii) determining the terrain height along the horizontal component of a single footstep (block 3204), (iii) determining state constraints for the footstep (block 3206), and (iv) calculating an optimized trajectory based on the determined horizontal and vertical components along with other associated pre-determined factors (e.g., velocity limits, torque limits, acceleration limits, jerk limits, minimum buffer height, and other constraints), wherein said optimized trajectory minimizes the cost (e.g., power consumption, mechanical wear, time, etc.) associated with the single footstep (block 3208). The same framework supports both swing-foot shaping for walking and flight-phase shaping for running, with the model order and boundary conditions selected per gait.

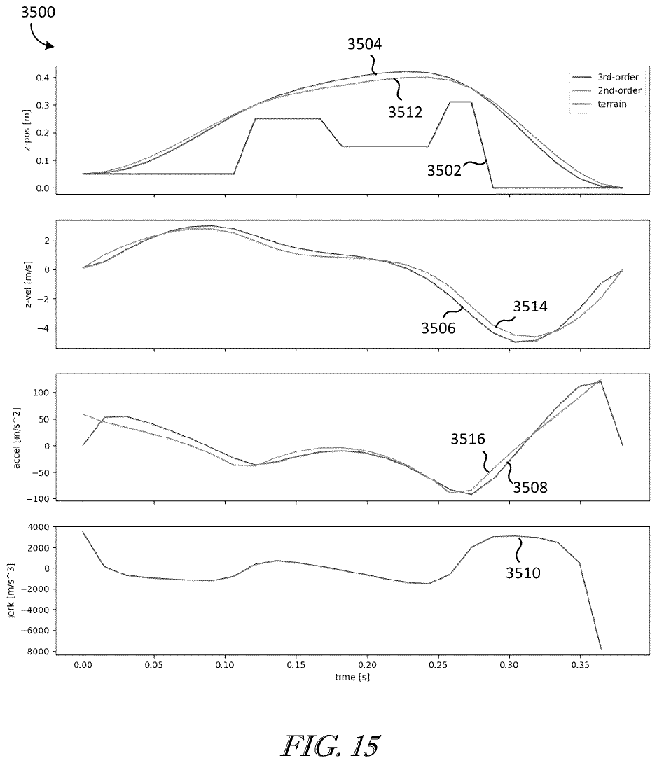

Flowchart 3300, as shown in FIGS. 13-14, illustrates a detailed method for optimizing foot trajectories that may be executed by the humanoid robot 1. The method 3300 begins in block 3302, in which the humanoid robot 1 sets values or ranges for one or more kinematic parameters for optimizing a foot trajectory associated with a single footstep. The kinematic parameters may include: (i) the foot swing time or period T, (ii) horizontal velocity, (iii) the desired swing length (e.g., horizontal velocity times swing duration), (iv) minimum vertical height, (v) a height buffer (i.e., a safety margin or other tolerance), (vi) liftoff velocity, (vii) horizontal acceleration, (viii) vertical velocity, (ix) vertical acceleration, (x) maximum swing length, (xi) minimum swing length, (xii) maximum vertical height, (xiii) minimum and maximum torque or amperage values, (xiv) ground-seeking velocity, and/or any other known kinematic parameter. The setting of the values or ranges for the kinematic parameters may be based on: (i) a static value that is pre-programmed into the humanoid robot 1, (ii) a dynamic value that is selected based upon: (a) environmental conditions, (b) the task (e.g., provided to the humanoid robot 1 via a natural language command), and/or (c) a combination of both. In one approach, phase durations are also treated as decision variables so that timing adapts with terrain and task.

In block 3304, the humanoid robot 1 sets the value or ranges for one or more solver parameters. Said solver parameters can include: (i) the number of samples (e.g., between 1 and 100, preferably between 10 and 40 samples per swing period or footstep), which may define the plurality of points for constraint evaluation, (ii) the time interval (e.g., swing time divided by number of samples, which may be represented as dt), (iii) tolerance values, and (iv) one or more cost terms (e.g., cost parameters Q, which may be represented as cost values for position Qz, velocity Qz, acceleration Qz, and jerk Qz that define the weighted cost terms of the cost function). The setting of the values or ranges for the solver parameters may be based on: (i) a static value that is pre-programmed into the humanoid robot 1, (ii) a dynamic value that is selected based upon: (a) environmental conditions, (b) the task (e.g., provided to the humanoid robot 1 via a natural language command), and/or (c) a combination of both. For example, the number of samples may be set at a higher rate when the humanoid robot 1 is commanded to climb a set of stairs compared to a normal or lower rate when the humanoid robot 1 is commanded to walk on a flat surface. In another example, the tolerance values may be larger when the humanoid robot 1 is walking on a surface that has a high friction coefficient compared to smaller tolerance values when the humanoid robot 1 is walking on a surface that has a lower friction coefficient. In some embodiments, the solver type is selected from a set that includes a fast quadratic program for convex subproblems and a nonlinear program for cases with timing or contact changes.

In block 3306, the humanoid robot 1 generates discrete time dynamics for the system used to model the foot swing. In some embodiments, in block 3308 the humanoid robot 1 may generate 3rd-order dynamics of the system. For example, the humanoid robot 1 may generate a representation of matrices A and B with dt equal to the current discrete time interval. The states of the 3rd-order dynamics system are defined as

$$x = [ \begin{matrix}z & \dot{z} & \ddot{z}\end{matrix} ] \qquad ( 1 )$$

and the control input u is the jerk, denoted as [symbol] . In this 3rd-order dynamics system, the discrete time dynamics of the system are represented as

$${x}_{i + 1} = {Ax}_{i} + {Bu}_{i} \qquad ( 2 )$$

$$where :$$

$$A = [ \begin{matrix}1 & dt & \frac{{dt}^{2}}{2} \\ 0 & 1 & dt \\ 0 & 0 & 1\end{matrix} ] B = [ \begin{matrix}\frac{{dt}^{3}}{6} \\ \frac{{dt}^{2}}{2} \\ dt\end{matrix} ] \qquad ( 3 )$$

In other embodiments, in block 3310 the humanoid robot 1 may generate 2nd-order dynamics of the system. For example, the humanoid robot 1 may generate a representation of matrices A and B with dt equal to the current discrete time interval. The optimal vertical (z) trajectory may be solved for by posing the following quadratic programming problem:

$$minimize {\sum }_{t = 0}^{T - 1} {x}_{t}^{T} {Q}_{t} {x}_{t} + {u}_{t}^{T} {Ru}_{t} \qquad ( 4 )$$

$$subject to {x}_{t + 1} = {Ax}_{t} + {Bu}_{t}$$

$${x}_{0} = {x}_{initial}$$

$${x}_{T} = {x}_{final}$$

$${z}_{i} \geq {z}_{ground , i} + {margin}_{i}$$

The discrete time dynamics of the 2nd-order system may be represented as indicated in Equation (2) above, where

$$A = [ \begin{matrix}1 & dt \\ 0 & 1\end{matrix} ] B = [ \begin{matrix}\frac{d {t}^{2}}{2} \\ dt\end{matrix} ] \qquad ( 5 )$$

Using these 2nd-order dynamics, the humanoid robot 1 may solve a similar optimization problem as described above in connection with Equation (4). The selection between 2nd-order and 3rd-order models may depend on actuator bandwidth and the smoothness constraints desired at touchdown.

In block 3312, the humanoid robot 1 determines a horizontal trajectory for a single footstep given the selected: (i) values or ranges for one or more kinematic parameters (e.g., swing length and horizontal velocity), and (ii) value or ranges for one or more solver parameters. Given said kinematic parameters and solver parameters, the humanoid robot 1 may determine that the horizontal trajectory should follow a cubic spline. The cubic spline may be beneficial due to its computational efficiency, its flexible control of waypoints and parameter adjustment, and its smoothness, providing C2 continuity. The position function S(t) can be defined as:

$$S ( t ) = {a}_{0} + {a}_{1} t + {a}_{2} {t}^{2} + {a}_{3} {t}^{3}$$

To solve for the coefficients a₀ to a₃, we set up the following system of equations:

$$At t = {t}_{0} : S ( {t}_{0} ) = {a}_{0} + {a}_{1} {t}_{0} + {a}_{2} {t}_{0}^{2} + {a}_{3} {t}_{0}^{3} = {z}_{0}$$

$$At t = {t}_{1} : S ( {t}_{1} ) = {a}_{0} + {a}_{1} {t}_{1} + {a}_{2} {t}_{1}^{2} + {a}_{3} {t}_{1}^{3} = {z}_{max}$$

$$At t = {t}_{2} : S ( {t}_{2} ) = {a}_{0} + {a}_{1} {t}_{2} + {a}_{2} {t}_{2}^{2} + {a}_{3} {t}_{2}^{3} = {z}_{0}$$

$$At t = {t}_{0} : {a}_{1} + 2 {a}_{2} {t}_{0} + 3 {a}_{3} {t}_{0}^{2} = 0$$

$$At t ≐ {t}_{2} : {a}_{1} + 2 {a}_{2} {t}_{2} + 3 {a}_{3} {t}_{2}^{2} = 0$$

where S(t) is the horizontal position function (trajectory) of the foot over time, \dot{S}(t) is the first derivative with respect to time, representing the horizontal velocity, and the boundary conditions are applied at start time (t₀, t₁, t₂) to ensure the trajectory starts and ends at the correct horizontal positions (e.g., xinitial, xfinal) with the desired horizontal velocities (vx,initial, vx,final). Given other parameters, the horizontal trajectory may follow a quintic spline, a Bezier curve, a Non-Uniform Rational B-Spline (NURBS), or a different polynomial trajectory. It should be understood that the humanoid robot 1 may determine the horizontal trajectory for a single footstep based on a given planar trajectory, such as a planar trajectory provided by the foot placement planner 1360 or other component of the computing architecture 1100. In some cases, a three-waypoint minimum-snap spline is used with a midpoint height that aligns the swing toe to the local ground plane estimated from perception.

Once the horizontal trajectory for a single footstep is determined in block 3312, the humanoid robot 1 determines an initial horizontal position from the horizontal trajectory in block 3314. The determined initial horizontal position may then be used by the humanoid robot 1 to determine an initial vertical position based on measured terrain height at said initial horizontal position in block 3316. The terrain height can be determined along the trajectory by evaluating the horizontal trajectory at discrete time points. For example, the humanoid robot 1 may divide an expected time for the foot swing into a number of equal time intervals (e.g., matching the solver's time interval dt and the number of samples), determine the horizontal position for each time interval to define a plurality of points, and then look up the terrain height at each corresponding horizontal position. Additionally, the terrain height may be determined based on obtaining sensor data, for example, using one or more sensors of the humanoid robot 1 (e.g., vision sensors 1.2.8.6, sound sensors 1.2.8.8, touch sensors 1.2.8.10, proximity sensors 1.2.8.12, LIDAR, RADAR, and/or other sensors capable of determining terrain height). Additionally or alternatively, the terrain height may be determined based on one or more models of the terrain, for example generated based on mapping data, such as a pre-existing digital twin, or other data describing a known environment of the humanoid robot 1.

In blocks 3318 and 3320, the humanoid robot 1 determines a final horizontal position from the horizontal trajectory and a final vertical position based on the terrain height at the final horizontal position, which is the anticipated touchdown location. In block 3322, the humanoid robot 1 determines initial and final state constraints based on the determined vertical position and vertical velocity. For example, the initial state may have vertical position equal to the initial vertical position and vertical velocity equal to the liftoff velocity. Continuing that example, the final state may have vertical position equal to the final vertical position and the ground-seeking velocity. In some embodiments, in block 3324, for a system with 3rd-order dynamics, the humanoid robot 1 may set both the initial and final state constraints to have vertical acceleration equal to zero, ensuring a smooth liftoff and touchdown.

In block 3326, the humanoid robot 1 may scale weights for the control problem by the time step dt. For example, for 3rd-order dynamics the humanoid robot 1 may multiply values for Q (e.g., a diagonal matrix of Q_{z}, Q_{ż}, Q_{\ddot{z}}) and R (e.g., [symbol] ) by dt. As another example, for 2nd-order dynamics, the robot 1 may multiply values for Q (e.g., a diagonal matrix of Q_{z}, Q_{ż}) and R (e.g., Q_{\ddot{z}}) by dt. Scaling the weights by dt may improve numerical stability and results of the optimization problem.

In block 3328, shown in FIG. 14, the humanoid robot 1 iterates for each time step dt in the swing length, and in block 3330 adds cost functions for the state term and control term. For example, the humanoid robot 1 may add a representation of the state term

$${x}_{t}^{T} {Q}_{t} {x}_{t}$$

and the control term

$${u}_{t}^{T} {Ru}_{t}$$

described above in Equation (4), for each time interval t in the swing length. In block 3332, for each time step the humanoid robot 1 adds a constraint for the system dynamics. For example, the humanoid robot 1 may add a representation of the discrete time dynamics described above in connection with Equation (2). For a system with 3rd-order dynamics, the humanoid robot 1 may represent Equation (2) using A and B as described above in connection with Equation (3), and for systems with 2nd-order dynamics the humanoid robot 1 may represent Equation (2) using A and B as described above in connection with Equation (5).

In block 3334, the humanoid robot 1 adds a constraint for a minimum swing height. The minimum swing height constraint may be added, for example, by adding a predetermined minimum swing height to the maximum of the initial vertical position and the final vertical position to determine a minimum height. A constraint is then added that vertical position can be at least the minimum height at one or more points within the foot swing trajectory. For example, the minimum height may be any value between 0.05 inches and 10 inches, preferably 1.5 inches. It should be understood that increasing the minimum height will increase the likelihood that the humanoid robot 1 will not trip on an obstacle; however, said increase may consume additional energy and slow the walking speed of the humanoid robot 1. Additionally, the minimum height may be dynamic or static, where: (i) the dynamic placement may allow the minimum height to be placed at any point during the step, it may adjust from step to step, and may be determined based on the environment and/or task, and (ii) the static height may be set to a specific point during the step regardless of the humanoid robot's environment. Specifically, the static minimum height constraint may be set for halfway through the swing (i.e., interval T/2). In another embodiment, the minimum height constraint may be set at two points equally distributed in the swing length (e.g., at intervals T/3 and 2T/3). This minimum swing height constraint may only come into effect if the terrain between the initial and final positions is substantially flat, for example to prevent the humanoid robot 1 from dragging its feet on flat ground.

In block 3336, the humanoid robot 1 iterates for each interior time step dt in the swing length. The interior time steps include all time steps other than the initial time step and the final time step. For example, in an embodiment where the initial time step is f1 and the final time step is t_{T-1}, the humanoid robot 1 may iterate over time steps t₂ to t_{T-2}. In block 3338, for each interior time step, the humanoid robot 1 adds a constraint that the vertical position is greater than terrain height plus a height buffer (e.g., as shown in Equation 4, zi≥zground,i+margini). The height buffer may be a predetermined safety margin, tolerance, or other buffer. In some embodiments, in block 3340 the humanoid robot 1 may phase the height buffer in and out gradually over the swing length. By reducing the buffer amount toward the beginning and end of the swing length, the humanoid robot 1 may ensure that the optimization problem is not over-constrained at liftoff or touchdown and thus may improve determination of the trajectory.

In block 3342, the humanoid robot 1 adds constraints for the initial state and the final state of the foot trajectory. The humanoid robot 1 may, for example, add representations of the initial and final state constraints (e.g., x0=xinitial and xT=xfinal) determined as described above in connection with block 3322.

In block 3344, the humanoid robot 1 minimizes the cost function(s) described above subject to the constraints described above using a quadratic programming solver. The humanoid robot 1 may use any appropriate technique to solve the described problem. After solving the quadratic programming problem, the humanoid robot 1 may determine a foot swing trajectory for the time period, including vertical position, vertical velocity, vertical acceleration, and (in systems with 3rd-order dynamics) vertical jerk for each time interval of the swing length. This determined vertical trajectory, combined with the determined horizontal trajectory, provides a complete executable footstep plan. This plan is then used to control one or more actuators of the humanoid robot 1 to execute the footstep. After solving the optimization problem, the method 3300 loops back to block 3312, shown in FIG. 13, in which the humanoid robot 1 may continue to solve for foot swing trajectories for additional time periods. In a related case, an event-triggered planner initiates a new step when a stance foot exits an ellipse around the hip, at which point the same trajectory pipeline sets swing references and body targets that the whole body controller 1550 tracks under contact constraints.

b. Simulation Results

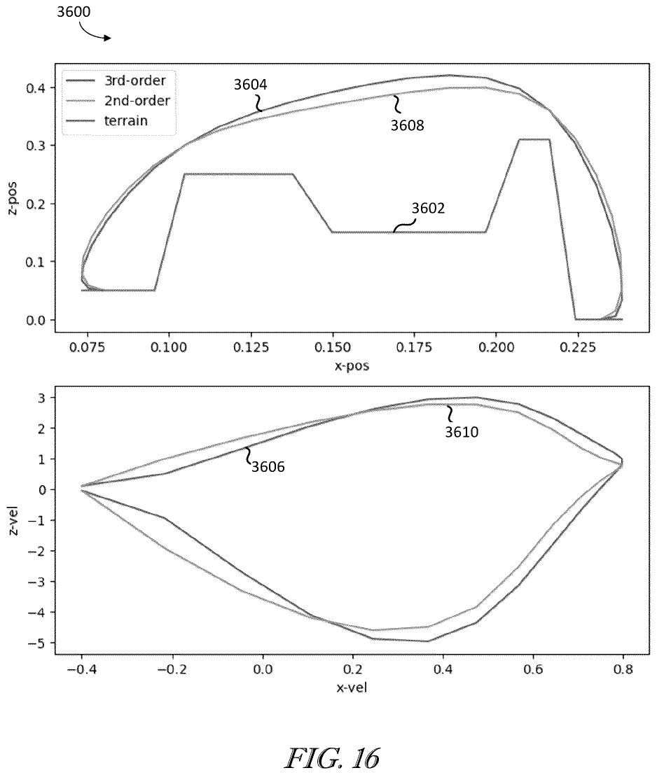

Referring now to FIG. 15, diagram 3500 illustrates simulated results that may be achieved by a humanoid robot 1 performing the methods of FIGS. 12-14. In the illustrative embodiment, the terrain was simulated as a one-dimensional function z of horizontal position x. Vertical foot swing trajectories were determined using 3rd-order dynamics and 2nd-order dynamics. The diagram 3500 includes charts representing the illustrative terrain, as well as calculated vertical position, velocity, acceleration, and jerk versus time for a simulated robot step. Curve 3502 shows the illustrative terrain. Curves 3504, 3506, 3508, and 3510 show position, velocity, acceleration, and jerk, respectively, for a 3rd-order dynamics system. Curves 3512, 3514, and 3516 show position, velocity, and acceleration, respectively, for a 2nd-order dynamics system. As described above, jerk is not a state or control variable for a 2nd-order dynamics system. The comparison indicates that the 3rd-order model shapes touchdown smoothness by directly penalizing jerk, while the 2nd-order model achieves smoothness through state and control weights.

Referring now to FIG. 16, diagram 3600 illustrates additional simulated results that may be achieved by a humanoid robot 1 performing the methods of FIGS. 12-14. Diagram 3600 illustrates simulated results for the same illustrative embodiment shown in FIG. 15. The diagram 3600 includes charts illustrating vertical position versus horizontal position and vertical velocity versus horizontal velocity for the simulated foot swing trajectory. Curve 3602 shows the illustrative terrain. Curve 3604 shows vertical position versus horizontal position, and curve 3606 shows vertical velocity versus horizontal velocity for 3rd-order dynamics. Curve 3608 shows vertical position versus horizontal position, and curve 3610 shows vertical velocity versus horizontal velocity for 2nd-order dynamics. The trajectories remain free of self-collision and terrain collision under the constraints described above.

### H. ALTERNATIVE EMBODIMENTS

The solving time for the quadratic programming problem may be reduced by reducing the number of samples used in solving the problem. However, reducing the number of samples may increase the possibility of terrain collisions due to samples not being taken in the correct location. To reduce the possibility of terrain collisions, in some embodiments, the humanoid robot 1 may continue to sample at uniform intervals and convolve the samples (thus spreading them across a region). This technique may work under the assumption that terrain is locally consistent within a small region. In other embodiments, the humanoid robot 1 may sample the terrain more densely and take the peak terrain height within the reduced number of optimization sample bins in order to avoid clipping the feet on step-like obstacles.

Additionally or alternatively, in other embodiments a variety of other solutions may be used to determine vertical foot swing trajectory rather than performing quadratic programming. In the most basic of situations, a z-trajectory can be planned between a starting height z₀ and an ending height z_{f}, with a single knot point at time T/2 where the knot is located at max (z₀, z_{f})+z_{margin}. This simple approach works well for any terrain that falls along the line between z₀ and z_{f}. However, there may be a risk of collision with the terrain for any case where the terrain protrudes above the line passing between z₀ and z_{f}.

By making some simplifying assumptions, the chances of the z trajectory avoiding collisions may be improved. One assumption is that the terrain can be modeled as step-like obstacles. If this assumption is made, a trajectory that is less round and more square-like will perform well in avoiding terrain. The problem then lies in determining how square the trajectory should be. If instead of a single knot at T/2, two knots were used, equally spaced from the center of the trajectory, this would start to generate a more square trajectory (more square as the knots get further from T/2). With increasing distance from T/2, there will also be higher peak velocities and accelerations. Therefore, a balance must be found between the proximity of the knot points to the ends of the trajectory and the acceptable accelerations. If accelerations are not a problem, the solution that leads to the least likelihood of collision will be to get the foot as high as suitable and as early as possible in the trajectory and leave it there as late as possible in the trajectory. This may present adverse implications due to reaction forces on the body and an increase in actuator torque demands.

One potential approach to answering the question of where the knot points should be located is to sample the terrain starting from each end of the trajectory and working towards the center. The location and height of the peak value can be recorded, and knot points can be placed accordingly. This may however still result in collisions with the terrain. In reality, rather than relying on absolute heights, the height gradient may be more relevant. If for example, the height gradient is very steep at t=0.257, but the peak height occurs at t=0.48T, where the gradient between t=0.257 and t=0.48T is much lower, then a knot point at t=0.25T will likely be much more beneficial in avoiding collisions with the terrain.

Using this same concept, it can be decided that three knot points may be more beneficial than just two, where the humanoid robot 1 searches for the correct phase and height of knot points 1 and 3 as outlined above, but knot point 2 is always placed at 1=0.5T. In some embodiments, this approach may be increased to a larger number of knot points, such as 4 or 5 or N knot points. This technique may then begin to approach the quadratic-programming-based approach described above in connection with FIGS. 12-16.

Additionally or alternatively, in some embodiments the humanoid robot 1 may use a sampling-based approach, in which the samples are taken in trajectory space. In this approach, the humanoid robot 1 may likely arrive at a collision avoiding trajectory that is non-optimal but derived more quickly as compared to the quadratic-programming-based approach. The proposed approach is to always use two knot points that move increasingly further from t=T/2 and increasingly higher. The humanoid robot 1 may use zₚₑₐₖ=max(z₀, z_{f})+z_{margin} to determine the z component of the knot points, but as the knot points separate further from t=T/2, the value of z_{margin} will also increase, resulting in multiple trajectories that span from rounded and shallow to tall and square. A discrete number of sampled trajectories may be used and pre-computed, all of which will likely take a fraction of the time required to solve for the QP-based solution. While the result will be sub-optimal, it may be computed more quickly. Rather than sampling the terrain and using that to solve for the swing trajectory, the humanoid robot 1 may sample from the various swing trajectories, and those swing trajectories will be checked for validity against the terrain.

It is to be understood that the invention is not limited to the exact details of construction, operation, exact materials or embodiments shown and described, as obvious modifications and equivalents will be apparent to one skilled in the art. While the specific embodiments have been illustrated and described, numerous modifications come to mind without significantly departing from the spirit of the invention, and the scope of protection is only limited by the scope of the accompanying Claims. For example, the humanoid robot 1 may use a solver type that may be based on: (i) interior-point methods that transform the constrained optimization problem into a series of unconstrained problems using barrier functions, (ii) direct collocation, which transforms trajectory optimization into a finite-dimensional nonlinear programming (NLP) problem by discretizing the state and control trajectories over time, (iii) gradient-based methods (e.g., Conjugate Gradient, BFGS, Limited-memory BFGS (L-BFGS)), (iv) global optimization methods (e.g., Genetic Algorithms, Simulated Annealing, Particle Swarm Optimization), (v) a linear solver, (vi) trajectory optimization using direct collocation and sparse solvers, with an optimization solver that uses an interior-point method like IPOPT and a linear solver that employs a sparse linear solver like MA57 or MUMPS within IPOPT, (vii) online optimization with model predictive control (MPC) and interior-point methods with an optimization solver that uses an interior-point method tailored for speed (e.g., OSQP) and a linear solver that uses a direct method optimized for small to medium-sized problems, and/or (viii) a combination of the disclosed methods and/or systems. In one embodiment, step placement is computed by a discrete-time predictive planner based on LIPM or ALIP dynamics with a quadratic stage cost on CoM tracking and changes in step position, and the outputs drive the whole body controller 1550 that solves a task-space quadratic program in joint accelerations, contact forces, and torques.

Additionally, the following techniques, algorithms, programming, and/or methods can be used instead of the above-described methods or in addition to said methods. For example, the humanoid robot 1 may use convex optimization, which allows the problem to be formulated in a way that ensures global optima and efficient solutions. Techniques such as Second-Order Cone Programming (SOCP) and Semidefinite Programming (SDP) may be utilized. Additionally, mixed-integer programming introduces both continuous and discrete variables, which may be desirable for problems involving footstep placement where decisions are made about specific contact points and timing. Mixed-Integer Quadratic Programming (MIQP) and Mixed-Integer Linear Programming (MILP) optimize these variables, making them highly applicable for navigation on uneven surfaces and challenging terrains. In a related embodiment, steppable convex polygons are extracted from elevation maps and passed to an MIQP footstep planner that selects footholds and timings over a short horizon within bounds that respect friction and kinematic reach.

Additionally and/or alternatively, the humanoid robot 1 may use hierarchical planning and control methods that offer a structured approach by separating trajectory planning into high-level planning, mid-level trajectory generation, and low-level control. This hierarchy allows for a strategic, multi-layered process that combines footstep planning with precise foot swing trajectory generation and stable control execution, improving adaptability in environments with obstacles. Instead, the humanoid robot 1 may use a robust optimization under uncertainty, which aims to produce trajectories that remain feasible despite variances in the model or environment. By incorporating techniques like chance-constrained optimization or worst-case scenario optimization, the trajectory can be optimized for stability even in variable conditions, such as fluctuating friction or terrain compliance. Alternatively, contact implicit optimization (CIO) simultaneously optimizes the trajectory and the associated contact forces, allowing the humanoid robot 1 to autonomously determine the optimal timing and location of foot contacts. This method is particularly effective for complex and dynamic maneuvers where predefined contact points are unknown.

Further, said humanoid robot 1 may additionally or alternatively use differential dynamic programming (DDP) that utilizes an iterative, second-order approach that optimizes control by expanding the dynamics and cost to second order, achieving accurate control inputs suited to complex, nonlinear systems. For periodic or predictable tasks, event-based trajectory planning leverages event triggers rather than continuous updates, using state machines or event-triggered control, simplifying control logic and making it efficient for periodic footstep planning. Further, said humanoid robot 1 may use a constraint-based programming method that is designed to determine trajectory optimization by setting desired conditions without specifying how to achieve them. This approach, combined with task-space control, allows precise control over end-effector tasks, especially in scenarios involving the satisfaction of multiple complex constraints. In a further embodiment for straight-leg walking, the whole body controller 1550 adopts an underconstrained formulation in the vertical direction and projects a preferred straight-leg posture into the null space so legs extend while balance tasks remain satisfied.

In further embodiments, the control architecture may utilize a two-layer approach comprising a discrete-time model predictive control (MPC) layer and a whole-body operational space control layer. The MPC layer may solve a quadratic program (QP) over future foot positions based on a simplified model, such as the Linear Inverted Pendulum Model (LIPM) or Angular Momentum Linear Inverted Pendulum (ALIP) model, to determine optimal foot placement. The output of this MPC layer may then be fed into a low-level task-space QP that solves for joint accelerations, contact forces, and torques while enforcing full rigid-body dynamics and friction constraints. In another embodiment, step timing and footstep positions are adjusted online by solving a small QP that embeds feedback on a reduced-order state such as the instantaneous capture point, while the whole body controller 1550 tracks the updated references.

To handle complex or uneven terrain, the perception system 1420 may generate elevation maps from depth data (e.g., from LIDAR or stereo cameras). These elevation maps may be segmented into planar regions and classified by slope and roughness. The computing architecture 1100 may then extract steppable convex polygons from these regions, potentially using a greedy optimization process to ensure convexity. These convex polygons can then serve as foothold constraints for the foot placement planner 1360 or MPC engine 1364, ensuring that planned steps land on viable terrain. Where footholds are partial, the support polygon used in control may shrink based on measured center-of-pressure histories and observed foot rotation, and the whole body controller 1550 adjusts contact forces and body motion to maintain balance on lines or points.

In some embodiments, the foot swing trajectory may be defined using various spline formulations beyond standard cubic splines. For example, a minimum-snap spline with multiple waypoints (e.g., start, mid-swing, and end) may be used to explicitly align the swing foot with the local ground plane. Alternatively, 5th-order splines may be employed to allow for reactive replanning of the swing trajectory in real-time based on sensor data, such as to avoid a trip detected by LIDAR or IMU data during the swing phase. Furthermore, during flight phases of dynamic gaits (e.g., running), joint trajectories may be parameterized by 3rd-degree polynomials to shape jerk and minimize body orientation error at the next touchdown. In a further case, touchdown height uncertainty is handled by commanding a downward foot velocity near the expected contact and adjusting task weights in the whole body controller 1550 so the pelvis posture yields increased workspace until contact occurs.

Additionally, rather than utilizing fixed time steps for gait phases, the phase durations themselves may be treated as decision variables in the optimization problem. This allows the humanoid robot 1 to autonomously determine the optimal timing for swing and stance phases based on the terrain and task. In other examples, stepping may be event-triggered, such as triggering a new step when the stance foot exceeds a predefined boundary (e.g., an ellipse around the hip) relative to the center of mass.

In another embodiment, kinematic constraints, such as knee bend limits, may be enforced by retiming the gait phases. A QP-based formulation may be used to iteratively adjust step timing and foot locations to satisfy these kinematic constraints while maintaining balance, effectively utilizing proportional feedback mechanisms embedded within the QP to adjust plans in real-time. In yet another embodiment, to facilitate straight-leg walking or other specific gait styles, the standard LIPM-based planning may be augmented by adjusting a virtual centroid height. For example, a target virtual centroid height may be derived based on leg segment lengths and a prescribed height reduction factor, allowing for walking patterns that differ from those strictly dictated by a constant-height inverted pendulum model while still maintaining stability. In highly dynamic or time-critical scenarios, the system may employ a hybrid approach combining iterative optimization with a deterministic library-based fallback. This involves precomputing a family of candidate foot trajectories ranging from aggressive (e.g., “square” profiles with high-initial acceleration) to conservative (e.g., “rounded” profiles). In real-time, the system rapidly validates these precomputed trajectories against the current terrain profile in parallel, selecting the first collision-free trajectory without waiting for a full optimization solve.

To further enhance robustness against unperceived small obstacles or sensor noise, the system may employ advanced terrain sampling strategies. A “peak-within-bin” strategy may be used where the terrain along the planned path is densely sampled and then downsampled by taking the maximum height within each spatial bin, rather than an average. Alternatively, a convolution filter may be applied to the terrain heightmap to effectively “spread” the risk of sharp terrain features to neighboring regions, ensuring the optimizer accounts for obstacles that are near but not directly on the planned 1D path.

The trajectory optimization may also feature adaptive knot placement, where the timing of spline knots is not fixed (e.g., at T/2) but is treated as an optimization variable. A gradient-driven approach may be used to shift knot timings to satisfy constraints, such as moving a peak earlier in the swing to clear a near-field obstacle. The system may also employ an “escalation” strategy, first attempting a solve with a simple single-knot spline, and if infeasible, progressively increasing the complexity to 2, 3, or N knots to find a viable solution.

Furthermore, the phased height buffer described in block 3340 may be implemented using specific time-varying functions (e.g., splines) that explicitly guarantee a zero value at the exact moments of liftoff (t=0) and touchdown (t=T), while smoothly ramping up to the full safety margin during mid-swing. This prevents mathematical infeasibility at the boundaries while maintaining rigorous safety constraints throughout the motion. Finally, the overall control architecture may be designed with a modular backend that supports interchangeable solvers and optimization classes. The system may dynamically select between a fast QP solver (like OSQP) for standard steps and a more powerful nonlinear solver (like IPOPT) when adaptive knot placement is required. The architecture may also support “drop-in” replacement of the core control philosophy, allowing switching between the baseline QP-based trajectory generation and more complex whole-body methods like Differential Dynamic Programming (DDP) or Contact-Implicit Optimization (CIO) depending on the task complexity. In a further embodiment, stepping-stone traversal uses a kino-dynamic planner that enforces per-phase contact and friction constraints and passes COM and foot references to the whole body controller 1550 for torque-level tracking under full rigid-body dynamics.

### I. INDUSTRIAL APPLICATION

While the present disclosure shows several illustrative embodiments of a robot (in particular, a humanoid robot), it should be understood that these embodiments are designed to be examples of the principles of the disclosed assemblies, methods, and systems. They are not intended to limit the broad aspects of the disclosed concepts solely to the specific embodiments that have been illustrated. As will be realized by one skilled in the art, the disclosed robot, and its associated functionality and methods of operation, are capable of other and different configurations. Furthermore, several of its details are capable of being modified in various respects, all without departing from the fundamental scope of the disclosed methods and systems. For example, one or more of the disclosed embodiments, either in part or in whole, may be combined with another disclosed assembly, method, and system to create hybrid implementations. As such, one or more steps from the diagrams or components in the Figures may be selectively omitted or combined in a manner that is consistent with the principles of the disclosed assemblies, methods, and systems. Additionally, the order of one or more steps from the arrangement of components may be omitted or performed in a different order than what is explicitly described. Accordingly, the drawings, diagrams, and the detailed description provided herein are to be regarded as illustrative in nature, and not as restrictive or limiting, of the said humanoid robot. It should be understood that the use of the word “or” when separating element names in connection with a single reference number indicates that the same structure can have two or more different names. For example, the phrase “foot or hand assembly 56” indicates that the structure that is referenced by the number 56 can be referred to or claimed as either an “foot” or a “hand assembly.”

While the above-described methods and systems are primarily designed for use with a general-purpose humanoid robot, it should be understood that the disclosed assemblies, components, learning capabilities, or kinematic capabilities may be adapted for use with other types of robots. Examples of other such robots include, but are not limited to: an articulated robot (e.g., an arm having two, six, or ten degrees of freedom, etc.), a cartesian robot (e.g., rectilinear or gantry robots, robots having three prismatic joints, etc.), a Selective Compliance Assembly Robot Arm (SCARA) robot (e.g., a robot with a donut-shaped work envelope, with two parallel joints that provide compliance in one selected plane, with rotary shafts positioned vertically, with an end effector attached to an arm, etc.), a delta robot (e.g., a parallel link robot with parallel joint linkages connected with a common base, having direct control of each joint over the end effector, which may be used for pick-and-place or product transfer applications, etc.), a polar robot (e.g., a robot with a twisting joint connecting the arm with the base and a combination of two rotary joints and one linear joint connecting the links, having a centrally pivoting shaft and an extendable rotating arm, a spherical robot, etc.), a cylindrical robot (e.g., a robot with at least one rotary joint at the base and at least one prismatic joint connecting the links, with a pivoting shaft and an extendable arm that moves vertically and by sliding, with a cylindrical configuration that offers vertical and horizontal linear movement along with rotary movement about the vertical axis, etc.), a self-driving car, a kitchen appliance, construction equipment, or a variety of other types of robot systems. The robot system may include one or more sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art and is used in connection with robot systems. Likewise, the robot system may omit one or more of the aforementioned sensors (e.g., cameras, temperature sensors, pressure sensors, force sensors, inductive or capacitive touch sensors), motors (e.g., servo motors and stepper motors), actuators, biasing members, encoders, a housing, or any other component that is known in the art to be used in connection with robot systems. In other embodiments, other configurations or components may be utilized.

As is well known in the data processing and communications arts, a general-purpose computer typically comprises a central processor or other processing device, an internal communication bus, various types of memory or storage media (e.g., RAM, ROM, EEPROM, cache memory, disk drives, etc.) for code and data storage, and one or more network interface cards or ports for communication purposes. The software functionalities that are described herein involve programming, which includes executable code as well as associated stored data. This software code is executable by the general-purpose computer. In operation, the code is stored within the memory of the general-purpose computer platform. At other times, however, the software may be stored at other locations or transported for loading into the appropriate general-purpose computer system.

A server, for example, typically includes a data communication interface for engaging in packet data communication over a network. The server also includes a central processing unit (CPU), which may be in the form of one or more processors, for executing the program instructions. The server platform typically includes an internal communication bus, program storage, and data storage for the various data files that are to be processed or communicated by the server, although the server often receives its programming and data via network communications. The hardware elements, operating systems, and programming languages of such servers are conventional in nature, and it is presumed that those who are skilled in the art are adequately familiar therewith. The server functions may be implemented in a distributed fashion on a number of similar platforms to distribute the processing load.

Hence, aspects of the disclosed methods and systems that are outlined above may be embodied in the form of computer programming. Program aspects of the technology may be thought of as “products” or “articles of manufacture,” which are typically in the form of executable code or associated data that is carried on or embodied in a type of machine-readable medium. “Storage” type media includes any or all of the tangible memory of the computers, processors, or the like, or any associated modules thereof. This may include various semiconductor memories, tape drives, disk drives, and the like, which may provide non-transitory storage at any time for the software programming. All or portions of the software may at times be communicated through the Internet or various other telecommunication networks. Thus, another type of media that may bear the software elements includes optical, electrical, and electromagnetic waves, such as those that are used across physical interfaces between local devices, through wired and optical landline networks, and over various air-links. The physical elements that carry such waves, such as wired or wireless links, optical links, or the like, also may be considered as media that bear the software. As used herein, unless specifically restricted to non-transitory, tangible “storage” media, terms such as computer or machine “readable medium” refer to any medium that participates in the process of providing instructions to a processor for execution.

A machine-readable medium may take many forms, including but not limited to, a tangible storage medium, a carrier wave medium, or a physical transmission medium. Non-volatile storage media include, for example, optical or magnetic disks, such as any of the storage devices in any computer or computers or the like, such as may be used to implement the disclosed methods and systems. Volatile storage media include dynamic memory, such as the main memory of such a computer platform. Tangible transmission media include components such as coaxial cables, copper wire, and fiber optics, including the wires that comprise a bus within a computer system. Carrier-wave transmission media can take the form of electric or electromagnetic signals, or acoustic or light waves, such as those that are generated during radio frequency (RF) and infrared (IR) data communications. Common forms of computer-readable media therefore include, for example: a floppy disk, a flexible disk, a hard disk, magnetic tape, any other magnetic medium, a CD-ROM, a DVD or DVD-ROM, any other optical medium, punch cards, paper tape, any other physical storage medium with patterns of holes, a RAM, a PROM and EPROM, a FLASH-EPROM, any other memory chip or cartridge, a carrier wave that is transporting data or instructions, cables or links that are transporting such a carrier wave, or any other medium from which a computer can read programming code or data. Many of these forms of computer-readable media may be involved in carrying one or more sequences of one or more instructions to a processor for execution.

It is to be understood that the invention is not limited to the exact details of construction, operation, exact materials, or specific embodiments shown and described herein, as obvious modifications and equivalents will be apparent to one who is skilled in the art. While the specific embodiments have been illustrated and described in detail, numerous modifications may come to mind without significantly departing from the spirit of the invention, and the scope of protection is only limited by the scope of the accompanying Claims. In the drawings, some structural or method features may be shown in specific arrangements or orderings. However, it should be appreciated that such specific arrangements or orderings may not be required. Rather, in some embodiments, such features may be arranged in a different manner or order than shown in the illustrative figures. Additionally, the inclusion of a structural or method feature in a particular figure is not meant to imply that such a feature is required in all embodiments and, in some embodiments, may not be included or may be combined with other features.

It should also be understood that the term “substantially” as utilized herein means a deviation of less than 15% and preferably less than 5%. It should also be understood that the term “near” means within 10 cm, the term “proximate” means within 5 cm, and the term “adjacent” means within 1 cm. It should also be understood that other configurations or arrangements of the above-described components are contemplated by this Application. Moreover, the description provided in the background section should not be assumed to be prior art merely because it is mentioned in or associated with the background section. The background section may include information that describes one or more aspects of the subject of the technology. Finally, the mere fact that something is described as conventional does not mean that the Applicant admits it is prior art.

The following applications are hereby incorporated by reference for any purpose: (i) PCT Application Nos. PCT/US25/10425, PCT/US25/11450, PCT/US25/12544, PCT/US25/16930, PCT/US25/19793, PCT/US25/23064, PCT/US25/23325, PCT/US25/24817, and PCT/US25/25005; (ii) U.S. patent application Ser. Nos. 18/919,263, 18/919,274, 19/000,626, 19/006,191, 19/033,973, 19/038,657, 19/064,596, 19/066,122, 19/180,106, 19/223,945, 19/224,109, 19/224,252, 19/249,517, 19/252,392, 19/252,708, 19/306,591, 19/319,712, 19/322,446, 19/323,751, 19/325,486, 19/325,415, 19/321,159, 19/324,342, 19/329,008, 19/329,474, 19/329,559, 19/337,845, 19/337,852, 19/337,899, 19/347,690, 19/342,470, 19/342,474, 19/347,994, 19/351,294, 19/352,959, 19/355,393, 19/321,022, 19/355,531, 19/355,786, 19/357,879, 19/358,414, 19/362,617, 19/363,293, 19/362,708, 19/377,127, 19/378,092, 19/378,308; and (iii) U.S. Design patents application Ser. Nos. 29/889,764, 29/928,748, 29/935,680, 29/954,572, 29/967,462, 29/993,115, 29/998,761, 30/024,341, 30/024,351, 30/024,102, 30/024,341, 30/026,493, 30/026,579, 30/026,737, 30/026,738, 30/026,746, 30/026,750, 30/026,978, and 30/024,351; (iv) U.S. Provisional Patent Application Nos. 63/556,102, 63/557,874, 63/558,373, 63/561,307, 63/561,311, 63/561,313, 63/561,315, 63/561,317, 63/561,318, 63/564,741, 63/565,077, 63/573,226, 63/573,528, 63/573,543, 63/574,349, 63/614,499, 63/615,766, 63/617,762, 63/620,633, 63/625,362, 63/625,370, 63/625,381, 63/625,384, 63/625,389, 63/625,405, 63/625,423, 63/625,431, 63/626,028, 63/626,030, 63/626,034, 63/626,035, 63/626,037, 63/626,039, 63/626,040, 63/626,105, 63/632,630, 63/632,683, 63/633,113, 63/633,405, 63/633,920, 63/633,931, 63/633,941, 63/634,042, 63/634,599, 63/634,697, 63/635,152, 63/677,087, 63/685,856, 63/690,334, 63/692,747, 63/692,765, 63/694,253, 63/694,304, 63/696,507, 63/696,533, 63/697,793, 63/697,816, 63/700,749, 63/702,185, 63/705,715, 63/706,768, 63/707,547, 63/707,897, 63/707,949, 63/708,003, 63/715,117, 63/715,270, 63/720,222, 63/722,057, 63/753,670, 63/757,440, 63/759,665, 63/760,617, 63/763,209, 63/766,911, 63/770,620, 63/770,654, 63/772,440, 63/773,078, 63/776,429, 63/792,520, 63/819,533, 63/837,511, 63/837,536, 63/839,386, 63/839,517, 63/839,612, 63/839,880, 63/839,918, and 63/841,314, each of which is expressly incorporated by reference herein in its entirety.

In this application, to the extent any U.S. patents, U.S. patent applications, or other materials (e.g., articles) have been incorporated by reference, the text of such materials is only incorporated by reference to the extent that it does not conflict with the materials, statements, and drawings set forth herein. In the event of such a conflict, the text of the present document controls, and terms in this document should not be given a narrower reading in virtue of the way in which those terms are used in other materials incorporated by reference. It should also be understood that structures or features not directly associated with a robot cannot be adopted or implemented into the disclosed humanoid robot without careful analysis and verification of the complex realities of designing, testing, manufacturing, and certifying a robot for the completion of usable work nearby or around humans. Theoretical designs that attempt to implement such modifications from non-robotic structures or features are insufficient, and in some instances, woefully insufficient, because they amount to mere design exercises that are not tethered to the complex realities of successfully designing, manufacturing, and testing a robot.

1. A method for controlling one or more actuators of a humanoid robot, the method comprising:
setting kinematic parameters for a footstep, the kinematic parameters include a swing period;
setting kinematic parameters for the footstep, the kinematic parameters including a swing period;
determining a horizontal trajectory for the footstep to be executed over the swing period;
obtaining sensor data from at least one sensor associated with the humanoid robot;
determining, based on the horizontal trajectory and the sensor data, a plurality of terrain heights at a corresponding plurality of points along the horizontal trajectory;
formulating a quadratic programming (QP) problem to determine a vertical trajectory for the footstep, wherein the QP problem minimizes a cost function subject to a set of constraints, the set of constraints comprising:
an initial state constraint for the vertical trajectory;
a final state constraint for the vertical trajectory; and
a plurality of terrain avoidance constraints, each terrain avoidance constraint corresponding to one of the plurality of points, wherein each terrain avoidance constraint requires a vertical position of the vertical trajectory at the respective point to be greater than or equal to the terrain height determined for that point plus a height buffer;
solving the QP problem to determine the vertical trajectory; and
controlling one or more actuators of the humanoid robot to execute the footstep based on the determined horizontal trajectory and the determined vertical trajectory.

2. The method of claim 1, wherein formulating the QP problem further comprises generating 3rd-order dynamics of a system to model the footstep, wherein states of the 3rd-order dynamics system comprise vertical position, vertical velocity, and vertical acceleration, and a control input comprises vertical jerk.

3. The method of claim 2, wherein the cost function comprises a sum of weighted cost terms, the weighted cost terms including cost values for vertical position, vertical velocity, vertical acceleration, and vertical jerk.

4. The method of claim 2, wherein the initial state constraint and the final state constraint further comprise a vertical acceleration equal to zero.

5. The method of claim 1, wherein formulating the QP problem further comprises generating 2nd-order dynamics of a system to model the footstep, wherein states of the 2nd-order dynamics system comprise vertical position and vertical velocity, and a control input comprises vertical acceleration.

6. The method of claim 1, wherein determining the horizontal trajectory comprises determining the horizontal trajectory to follow a cubic spline.

7. The method of claim 1, wherein the height buffer is phased in and out gradually over the swing period, such that the height buffer is reduced toward a beginning of the swing period and an end of the swing period to ensure the QP problem is not over-constrained at liftoff or touchdown.

8. The method of claim 1, wherein the set of constraints further comprises a minimum swing height constraint that requires the vertical position of the vertical trajectory to be at least a predetermined minimum height at one or more points within the swing period.

9. The method of claim 8, wherein the minimum swing height constraint is set for a point halfway through the swing period to prevent the humanoid robot from dragging its foot on flat ground.

10. The method of claim 1, wherein the initial state constraint comprises an initial vertical position based on a terrain height at an initial horizontal position and a predetermined liftoff velocity, and wherein the final state constraint comprises a final vertical position based on a terrain height at a final horizontal position and a predetermined ground-seeking velocity.

11. The method of claim 1, further comprising: setting solver parameters including a number of samples and a time interval, wherein the plurality of points corresponds to the number of samples; and scaling weights for the cost function by the time interval.

12. A method for controlling one or more actuators of a humanoid robot, the method comprising:
producing a first action proposal using a first policy;
predicting a risk score of the first action proposal;
responsive to the risk score being at or below a threshold:
transmitting the first action proposal to a whole-body controller;
responsive to the risk score being above the threshold:
determining a bridge plan for use while a revised action proposal is being generated;
transmitting the bridge plan to the whole-body controller for immediate execution;
using a second policy to generate the revised action proposal, wherein the second policy is different from the first policy; and
transmitting the revised action proposal to the whole-body controller; and
using the whole-body controller to control the one or more actuators of the humanoid robot based on at least one of the first action proposal, the bridge plan, or the revised action proposal transmitted to the whole-body controller.

13. The method of claim 12, wherein the first policy comprises a reactive policy (S1) that generates detailed movement information for the whole-body controller, and wherein the second policy comprises a high-level policy (S2) that processes task and sensor data to generate abstract information.

14. The method of claim 13, wherein the high-level policy (S2) generates the abstract information provided to a semantic latent vector encoding an intent of an action, and wherein the reactive policy (S1) produces the first action proposal by processing the semantic latent vector.

15. The method of claim 12, wherein the first policy comprises a trained neural network selected from the group consisting of a transformer-based network and a diffusion policy.

16. The method of claim 12, wherein producing the first action proposal comprises fusing multiple data streams, the data streams comprising a standardized user command, real-time sensory data, and internal robot state data.

17. The method of claim 16, wherein the real-time sensory data comprises vision data from one or more camera sensors, and wherein the internal robot state data comprises proprioceptive information detailing current joint angles and velocities.

18. The method of claim 12, wherein predicting the risk score comprises predicting a probability of at least one of self-collision, terrain collision, or violating a joint limit.

19. The method of claim 12, wherein predicting the risk score comprises evaluating the first action proposal against predetermined stability margins.

20. The method of claim 12, wherein the first policy comprises a visuomotor model that directly generates robot action commands, and wherein the second policy comprises a hierarchical planning architecture that decomposes a command into a sequence of executable subtasks.
